(19) United States
(12) Patent Application Publication
(10) Pub. No.: US 2024/0319432 A1
(43) Pub. Date: Sep. 26, 2024

(54) OPTICAL APPARATUS AND IMAGE DISPLAY APPARATUS

(71) Applicant: SONY GROUP CORPORATION, TOKYO (JP)

(72) Inventor: NOBUYUKI SUZUKI, TOKYO (JP)

(21) Appl. No.: 18/577,070

(22) PCT Filed: Feb. 7, 2022
(86) PCT No.: PCT/JP2022/004639

§ 371 Date: Jan. 5, 2024

(30) Foreign Application Priority Data
Jul. 16, 2021 (JP) 2021-117984

(51) Int. Cl. F21V 8/00; G02B 27/01

(52) U.S. Cl. CPC G02B 6/0091; G02B 27/0172; G02B 27/0176; G02B 2027/0156; G02B 2027/0169

(57) ABSTRACT

The present technology provides an optical apparatus in which different light guide plate units can be used. The present technology provides an optical apparatus including: a light guide plate unit including a light guide plate; an optical unit that guides incident light to the light guide plate unit; and a fixing mechanism that detachably fixes the light guide plate unit to the optical unit. In accordance with the present technology, an optical apparatus in which different light guide plate units can be used can be provided.

### TECHNICAL FIELD

The technology according to the present disclosure (hereinafter, also referred to as “present technology”) relates to an optical apparatus and an image display apparatus.

### BACKGROUND ART

Conventionally, a wearable device integrally including a main body portion and a display unit is known (e.g., see Patent Literature 1).

### CITATION LIST

### Patent Literature

Patent Literature 1: Japanese Patent Application Laid-open No. 2018-189678

### DISCLOSURE OF INVENTION

### Technical Problem

However, a user needs to use constantly the same display unit in the conventional wearable device.

In view of such circumstances, it is a main objective of the present technology to provide an optical apparatus in which different light guide plate units can be used.

### Solution to Problem

The present technology provides an optical apparatus including:
a light guide plate unit including a light guide plate;
an optical unit that guides incident light to the light guide plate unit; and
a fixing mechanism that detachably fixes the light guide plate unit to the optical unit.

The fixing mechanism may include a positioning structure that positions the light guide plate unit and the optical unit.

The positioning structure may have at least one pin that penetrates the light guide plate, and the pin may have a portion on one end side protruding from the light guide plate, the portion being inserted in the optical unit.

The fixing mechanism may include a fixing unit fixed to the optical unit, the fixing unit having at least a portion located between the light guide plate unit and the optical unit, and a cap unit that covers the light guide plate unit at least from a side opposite to a side of the optical unit, the cap unit including a cap member attachable and detachable to/from the fixing unit, and the pin may penetrate the light guide plate and the at least portion.

The cap member may be attachable and detachable by being slid with respect to the fixing unit.

The cap member may slidably fit in the fixing unit.

The cap unit may further include a soft resin member disposed between the cap member and the light guide plate unit.

The pin may be fixed to the fixing unit and may not be fixed to the optical unit.

The pin may be fixed to the optical unit.

The light guide plate unit may further include a cover plate that is arranged so as to form a gap with respect to a surface of the light guide plate that is on the side of the optical unit, and/or a cover plate that is arranged so as to form a gap with respect to a surface of the light guide plate that is on a side opposite to the side of the optical unit.

The pin may have a portion on one end side protruding from the light guide plate and/or a portion of another end side, the portion being inserted in the cover plate.

The light guide plate unit may include a first fitting portion that substantially fits to the fixing unit, and the fixing unit may include a second fitting portion that substantially fits to the first fitting portion.

A plurality of sets of the first and second fitting portions that substantially fit to each other may be provided, and the first and second fitting portions of at least two sets of the plurality of sets may be different in shape.

One of the first and second fitting portions may be a cutout, and the other of the first and second fitting portions may be a convex portion that has a shape corresponding to a shape of the cutout and enters the cutout.

The light guide plate unit may include a frame-like member in which the light guide plate is fitted, the positioning structure may have at least one pin that penetrates the frame-like member, the pin may have a portion on one end side protruding from the frame-like member and inserted in the optical unit, and the fixing mechanism may further include a fixing member that detachably fixes to the optical unit the frame-like member pushed against the optical unit.

The fixing member may be a screw that is threadedly engaged with a threaded hole formed in the optical unit.

The at least one pin may be a plurality of pins.

The plurality of pins may include at least two pins having cross-sections different in shape.

The at least one pin may be a single pin having a polygonal cross-section.

The present technology also provides an image display apparatus including:
the above-mentioned optical apparatus; and
an image light generation unit that causes image light to enter an optical unit of the optical apparatus, in which
the image light that has passed through a light guide plate unit of the optical apparatus is made to enter an eyeball of a user.

The image light generation unit may be mounted to the optical unit.

The light guide plate unit may include an incident optical unit that causes the image light that has passed through the optical unit to enter the light guide plate, and an emission optical unit that emits the image light that has propagated inside the light guide plate towards the eyeball.

The light guide plate unit may further include an intermediate optical unit arranged on an optical path of the image light between the incident optical unit and the emission optical unit.

### BRIEF DESCRIPTION OF DRAWINGS

FIG. 1 A cross-sectional view of an optical apparatus according to a first embodiment of the present technology.

FIG. 2 A cross-sectional view of an image display apparatus including the optical apparatus in FIG. 1.

FIG. 3 A plan view of the optical apparatus in FIG. 1.

FIG. 4 A side view of the image display apparatus in FIG. 2.

FIG. 5 A perspective view of the optical apparatus in FIG. 1.

FIG. 6 A of FIG. 6 is a perspective view of a cap unit of the optical apparatus in FIG. 1. B of FIG. 6 is a perspective view showing a state in which the cap unit is detached from the optical apparatus shown in FIG. 5.

FIG. 7 A perspective view showing a state in which a cap member of the cap unit is removed from the optical apparatus shown in FIG. 5.

FIG. 8 A perspective view showing a state in which the interior of a fixing unit has been exposed by removing the cap member of the cap unit from the optical apparatus shown in FIG. 5 and omitting one side wall portion of the fixing unit.

FIG. 9 A perspective view showing the fixing unit and a light guide plate unit shown in B of FIG. 6 in a disassembled state.

FIG. 10 A flowchart for describing a manufacturing method for the light guide plate unit of the optical apparatus in FIG. 1.

FIG. 11 A of FIG. 11 to E of FIG. 11 are cross-sectional views (Part 1 to Part 5) for describing the manufacturing method for the light guide plate unit of the optical apparatus in FIG. 1.

FIG. 12 A flowchart for describing a manufacturing method for the cap unit of the optical apparatus in FIG. 1.

FIG. 13 A of FIG. 13 to D of FIG. 13 are cross-sectional views (Part 1 to Part 4) for describing the manufacturing method for the cap unit of the optical apparatus in FIG. 1.

FIG. 14 A flowchart for describing a manufacturing method for a fixing unit assembly of the image display apparatus in FIG. 2.

FIG. 15 A of FIG. 15 to C of FIG. 15 are cross-sectional views (Part 1 to Part 3) for describing the manufacturing method for the fixing unit assembly of the image display apparatus in FIG. 2.

FIG. 16 A of FIG. 16 and B of FIG. 16 are cross-sectional views (Part 4 and Part 5) for describing the manufacturing method for the fixing unit assembly of the image display apparatus in FIG. 2.

FIG. 17 A of FIG. 17 and B of FIG. 17 are cross-sectional views (Part 6 and Part 7) for describing the manufacturing method for the fixing unit assembly of the image display apparatus in FIG. 2.

FIG. 18 A of FIG. 18 and B of FIG. 18 are cross-sectional views (Part 8 and Part 9) for describing the manufacturing method for the fixing unit assembly of the image display apparatus in FIG. 2.

FIG. 19 A of FIG. 19 and B of FIG. 19 are cross-sectional views (Part 10 and Part 11) for describing the manufacturing method for the fixing unit assembly of the image display apparatus in FIG. 2.

FIG. 20 A cross-sectional view (Part 12) for describing the manufacturing method for the fixing unit assembly of the image display apparatus in FIG. 2.

FIG. 21 A flowchart for describing an assembling method for the image display apparatus in FIG. 2.

FIG. 22 A of FIG. 22 to C of FIG. 22 are cross-sectional views for describing the assembling method for the image display apparatus in FIG. 2.

FIG. 23 A of FIG. 23 is a side view of an optical apparatus according to a second embodiment of the present technology. B of FIG. 23 is a bottom view of the optical apparatus according to the second embodiment of the present technology.

FIG. 24 A side view of an image display apparatus including the optical apparatus in A of FIG. 23.

FIG. 25 A of FIG. 25 to D of FIG. 25 are side views (Part 1 to Part 4) for describing an assembling method for the image display apparatus in FIG. 24.

FIG. 26 A of FIG. 26 to C of FIG. 26 are side views (Part 5 to Part 7) for describing the assembling method for the image display apparatus in FIG. 24.

FIG. 27 A cross-sectional view of an optical apparatus according to Modified Example 1 of the first embodiment of the present technology.

FIG. 28 A plan view of the optical apparatus in FIG. 27.

FIG. 29 A cross-sectional view of an optical apparatus according to Modified Example 2 of the first embodiment of the present technology.

FIG. 30 A of FIG. 30 to D of FIG. 30 are views showing variations of a pin shape of the optical apparatus according to the present technology.

FIG. 31 A of FIG. 31 to D of FIG. 31 are views showing variations of a combination of pin shape and first fitting portion shape in the optical apparatus according to the present technology.

FIG. 32 A of FIG. 32 to D of FIG. 32 are views showing variations of pin shape and orientation in the optical apparatus according to the present technology.

FIG. 33 A of FIG. 33 to C of FIG. 33 are views showing variations of the number of pins and pin arrangement in the optical apparatus according to the present technology.

FIG. 34 A of FIG. 34 and B of FIG. 34 are views showing variations of a light guide plate shape in the optical apparatus according to the present technology.

FIG. 35 A view showing an example in which an incident optical unit, an intermediate optical unit, and an emission optical unit are provided in the light guide plate.

FIG. 36 A of FIG. 36 to D of FIG. 36 are views showing variations of the pin shape, the number of pins, and the presence/absence of the first fitting portion in the optical apparatus according to the present technology.

FIG. 37 A of FIG. 37 to D of FIG. 37 are views showing variations of the pin shape, the number of pins, and the pin arrangement in the optical apparatus according to the present technology.

FIG. 38 A of FIG. 38 to C of FIG. 38 are cross-sectional views for describing an assembling method for an image display apparatus including an optical apparatus according to Modified Example 3 of the first embodiment of the present technology.

FIG. 39 A side view of an image display apparatus including an optical apparatus according to Modified Example 4 of the first embodiment of the present technology.

FIG. 40 A view for describing damage of the light guide plate.

FIG. 41 A view showing an example of variations of design of the light guide plate.

### MODE(S) FOR CARRYING OUT THE INVENTION

Hereinafter, favorable embodiments of the present technology will be described in detail with reference to the accompanying drawings. It should be noted that in the present specification and the drawings, components having substantially the same functional configurations will be denoted by the same reference signs and duplicate descriptions thereof will be omitted. The embodiments described below represent typical embodiments of the present technology. The scope of the present technology should not be understood narrowly due to these embodiments. In the present specification, even in a case where it is described that an optical apparatus and an image display apparatus according to the present technology provide a plurality of effects, the optical apparatus and the image display apparatus according to the present technology only need to provide at least one of the effects. The effects described in the present specification are merely exemplary and not limitative and other effects may be provided.

Moreover, descriptions will be given in the following order.
1. Introduction
2. Optical Apparatus According to First Embodiment of Present Technology and Image Display Apparatus Including Optical Apparatus
(1) Configurations of Optical Apparatus and Image Display Apparatus
(2) Manufacturing Method for Light Guide Plate Unit
(3) Manufacturing Method for Cap unit
(4) Manufacturing Method for Fixing Unit Assembly
(5) Assembling Method for Image Display Apparatus
(6) Effects of Optical Apparatus and Image Display Apparatus
3. Optical Apparatus According to Second Embodiment of Present Technology and Image Display Apparatus Including Optical Apparatus
(1) Configurations of Optical Apparatus and Image Display Apparatus
(2) Assembling Method for Image Display Apparatus
(3) Effects of Optical Apparatus and Image Display Apparatus
4. Modified Examples of Present Technology

### 1. Introduction

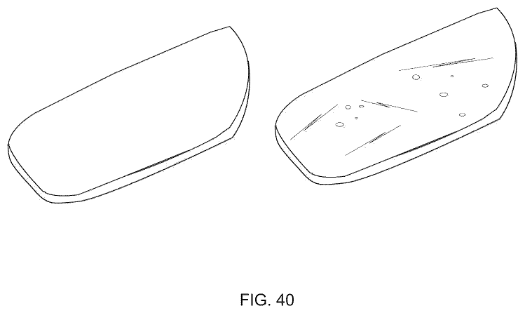

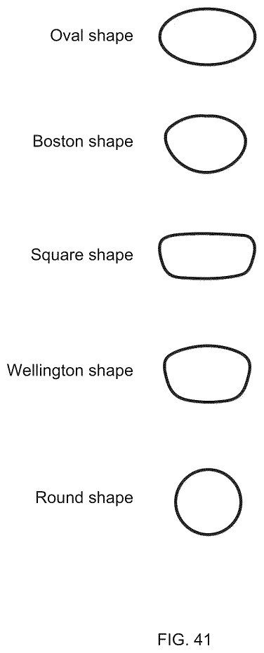

Conventionally, image display apparatuses (e.g., head-mounted displays) mounted on a user's head are known. Some of the conventional image display apparatuses integrally include a light guide plate unit and an optical unit that guides light to the light guide plate unit. In such an image display apparatus, both units are fixed with an adhesion or the like in a state in which optical alignment between the units has been adjusted. Therefore, the conventional image display apparatus has not enabled replacement of the light guide plate unit, so the user needs to buy a new image display apparatus for example in a case where the light guide plate unit gets dirty, in a case where it is damaged (referring to FIG. 40, the left view of FIG. 40 represents the light guide plate before it is damaged and the right view of FIG. 40 represents the light guide plate after it is damaged), in a case where the user wishes to change the design of the light guide plate unit (e.g., in a case where the user wishes to change the design between the designs shown in FIG. 41). That is, the user needs to use constantly the same light guide plate unit in the conventional image display apparatus.

Therefore, in view of such a problem, the inventor has developed an optical apparatus in which different light guide plate units can be used and an image display apparatus including the optical apparatus as an optical apparatus according to the present technology and an image display apparatus including the optical apparatus.

### 2. Optical Apparatus According to First Embodiment of Present Technology and Image Display Apparatus Including Optical Apparatus

An optical apparatus according to a first embodiment of the present technology and an image display apparatus including the optical apparatus will be described with reference to the drawings.

The optical apparatus according to the first embodiment and the image display apparatus including the optical apparatus are used for the purpose of providing augmented reality (AR) to a user, for example.

### (1) Configurations of Optical Apparatus and Image Display Apparatus

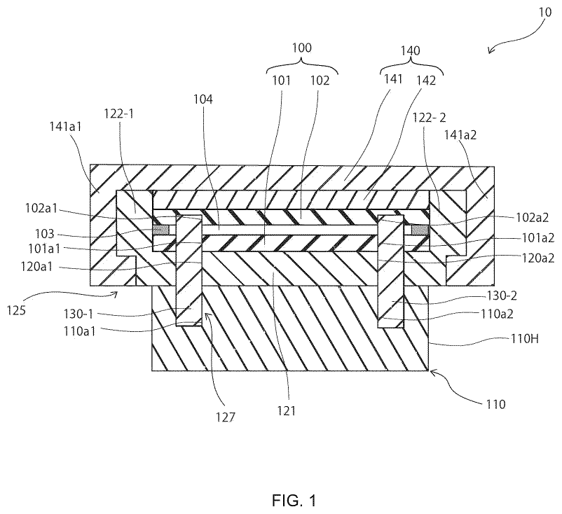

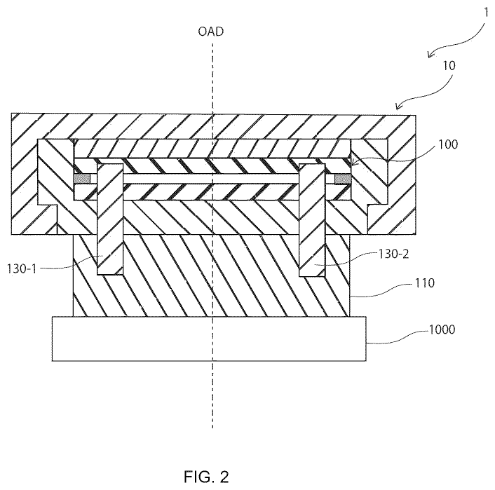

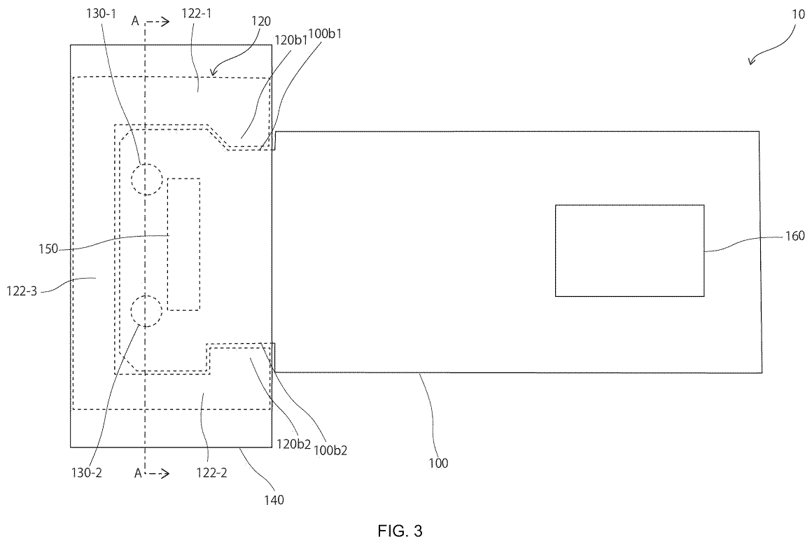

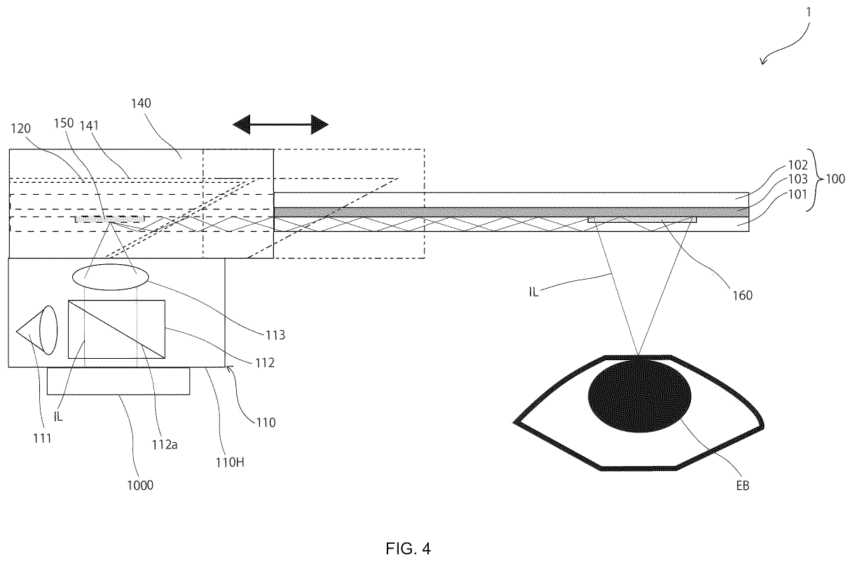

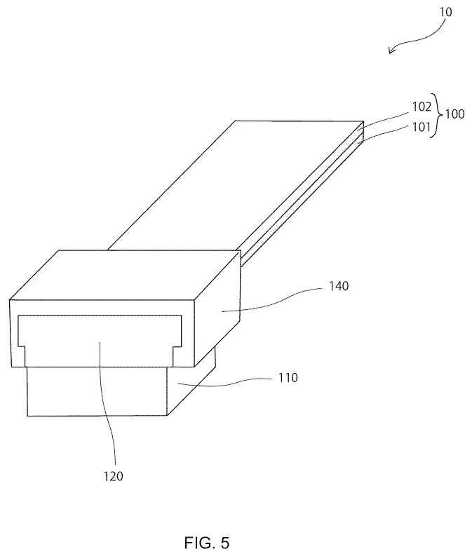

FIG. 1 is a cross-sectional view of an optical apparatus 10 according to the first embodiment. FIG. 2 is a cross-sectional view of an image display apparatus 1 including the optical apparatus 10. FIG. 3 is a plan view of the optical apparatus 10. FIG. 4 is a side view of the image display apparatus 1. FIG. 5 is a perspective view of the optical apparatus 10. It should be noted that FIG. 1 is a cross-sectional view taken along the line A-A in FIG. 3.
The image display apparatus 1 functions as a head-mounted display (HMD) mounted on the user's head for use, for example. The HMD is also called, for example, eyewear.

The image display apparatus 1 includes, as shown in FIG. 2, the optical apparatus 10 and an image light generation unit 1000. The image light generation unit 1000 generates image light and causes the image light to enter the optical apparatus 10.

The image display apparatus 1 displays an image by causing image light which has been generated by the image light generation unit 1000 and passed through the optical apparatus 10 to enter the eyeball of the user.

The optical apparatus 10 and the image light generation unit 1000 are provided in the same support structure (e.g., an eyeglass frame), for example.

### [Image Light Generation Unit]

The image light generation unit 1000 is mounted to an optical unit 110 of the optical apparatus 10 as an example, which will be described later.

The image light generation unit 1000 includes a liquid-crystal panel, for example. The image light generation unit 1000 generates image light by driving the liquid-crystal panel irradiated with light from a light source on the basis of image data.

Here, a reflective liquid-crystal panel is used as the liquid-crystal panel. However, a transmissive liquid-crystal panel may be used as the liquid-crystal panel.

### [Optical Apparatus]

The optical apparatus 10 includes a light guide plate unit 100, the optical unit 110, and a fixing mechanism 125 as shown in FIG. 1 and FIGS. 3 to 5, for example.

### (Optical Unit)

As an example, as shown in FIG. 4, image light IL generated by the image light generation unit 1000 enters the optical unit 110. The optical unit 110 guides the incident image light IL to the light guide plate unit 100.

The optical unit 110 is disposed between the image light generation unit 1000 and the light guide plate unit 100, for example.

The optical unit 110 integrally includes, for example, a light 111 as the light source, a prism 112, and a lens 113. The optical unit 110 further includes a casing 110H that houses the light 111, the prism 112, and the lens 113 while keeping them in a predetermined positional relationship, for example. The image light generation unit 1000 is mounted to the casing 110H. The casing 110H has an aperture or window portion through which the image light IL from the image light generation unit 1000 can pass.

The lens 113 is disposed between the prism 112 and the light guide plate unit 100, for example. The light 111 is, as an example, arranged on one side of the prism 112 in a direction orthogonal to an optical axis direction of the lens 113.

The optical unit 110 causes a portion of the light of the light 111 to be reflected on an optical surface 112a (e.g., a half mirror surface) of the prism 112, such that it enters substantially the entire surface of the liquid-crystal panel of the image light generation unit 1000. The image light generation unit 1000 drives pixels (e.g., liquid-crystals) on the basis of image data to reflect at least a portion of incident light so as to generate image light IL. A portion of the generated image light IL passes through the optical surface 112a of the prism 112 and is made to enter the light guide plate unit 100 via the lens 113.

Examples of the light 111 include a light-emitting diode (LED) and an organic electro-luminescence (EL) element.

### (Light Guide Plate Unit)

The light guide plate unit 100 is mounted to the eyeglass frame as the support structure described above, for example.

The light guide plate unit 100 integrally includes, for example, a light guide plate 101 and a cover plate 102.

The light guide plate unit 100 further includes an incident optical unit 150 and an emission optical unit 160 which are provided in the light guide plate 101 (see FIGS. 3 and 4).

The light guide plate 101 is constituted by for example a transparent glass plate or resin plate. The light guide plate has a thickness of 0.1 mm to 1.0 mm, for example. The light guide plate favorably has a thickness of 0.4 mm to 0.6 mm, for example.

The cover plate 102 are members that protect the light guide plate 101, the incident optical unit 150, and the emission optical unit 160. The cover plate 102 is constituted by a transparent glass plate or resin plate, for example.

The cover plate 102 has the same shape and the same size as the light guide plate 101, for example. The thickness of the cover plate 102 is, for example, substantially the same as the thickness of the light guide plate 101.

The cover plate 102 is fixed to the light guide plate 101 so as to form a gap 104 between the cover plate 102 and the light guide plate 101. To be specific, outer edges of the light guide plate 101 and the cover plate 102 are bonded to each other via an adhesion layer as an example, and the gap 104 is formed in a region inside the adhesion layer, which corresponds to a light propagation region inside the light guide plate 101 (see FIGS. 1 and 4). Accordingly, the cover plate 102 does not influence light propagation inside the light guide plate 101 (propagation due to total internal reflection).

Here, the cover plate 102 is provided so as to form a gap with respect to a surface of the light guide plate 101 that is on a side opposite to a side of the optical unit 110. Alternatively or additionally, the cover plate 102 may be provided so as to form a gap with respect to a surface of the light guide plate 101 that is on the side of the optical unit 110.

The incident optical unit 150 is provided at a position on the light guide plate 101 on the optical path of the image light IL passing through the optical unit 110 as shown in FIG. 4.

The incident optical unit 150 causes the incident image light IL to enter the inner surface of the light guide plate 101 so as to satisfy total internal reflection conditions inside the light guide plate 101 (at an angle of incidence at which it is totally internally reflected in the light guide plate 101 (at an angle of incidence equal to or larger than a critical angle).

The incident optical unit 150 can be, for example, a diffraction optical element. Here, a reflective diffraction optical element provided on a surface of the light guide plate 101 (surface on a side of the cover plate 102) that is on a side opposite to the side of the optical unit 110, is used as the incident optical unit 150. The cover plate 102 protects the reflective diffraction optical element together with the surface of the light guide plate 101 that is on the side of the cover plate 102.

It should be noted that a transmissive diffraction optical element may be, as the incident optical unit 150, provided on the surface of the light guide plate 101 that is on the side of the optical unit 110. In this case, the cover plate 102 is favorably provided so as to form a gap with respect to the surface of the light guide plate 101 that is on the side of the optical unit 110. This can protect the transmissive diffraction optical element and the surface of the light guide plate 101 that is on the side of the optical unit 110.

The emission optical unit 160 is provided at a position on the light guide plate 101 on the optical path of the image light IL propagating while being totally internally reflected in the light guide plate 101. The emission optical unit 160 emits the incident image light IL towards an eyeball EB of the user. The emission optical unit 160 can be, for example, a diffraction optical element. Here, a reflective diffraction optical element provided on a surface of the light guide plate 101 that is on a side opposite to a side of the eyeball EB of the user is used as the emission optical unit 160. The cover plate 102 protects the reflective diffraction optical element together with the surface of the light guide plate 101 that is on the side of the cover plate 102.

It should be noted that a transmissive diffraction optical element may be, as the emission optical unit 160, provided on a surface of the light guide plate 101 that is on the side of the eyeball EB. In this case, the cover plate 102 is favorably provided so as to form a gap with respect to the surface of the light guide plate 101 that is on the side of the eyeball EB. This can protect the transmissive diffraction optical element and the surface of the light guide plate 101 that is on the side of the eyeball EB.

Each of the above-mentioned diffraction optical elements may be formed therein by machining the corresponding surface of the light guide plate, for example, or may be those attached to the surface of the light guide plate. Here, each of the diffraction optical elements also includes a holographic optical element (HOE) other than a diffractive optical element (DOE) in a broad sense.

### (Fixing Mechanism)

Referring back to FIG. 1, the fixing mechanism 125 includes a fixing unit 120, a cap unit 140, and a positioning structure 127.

The fixing unit 120 is fixed to the optical unit 110 so that a portion of the fixing unit 120 is located between the light guide plate unit 100 and the optical unit 110.

To be specific, the fixing unit 120 is constituted by for example a box-shaped member having a bottom wall portion 121. Here, a side (upper side in FIG. 1) of the box-shaped member that is opposite to the bottom wall portion 121 and one side portion of the box-shaped member are opened (see FIG. 3). The bottom wall portion 121 is located between the light guide plate unit 100 and the optical unit 110 and is bonded to the optical unit 110 for example with an adhesion or the like. The bottom wall portion 121 has a passage portion (aperture or window portion) through which the image light IL passing through the optical unit 110 passes. The image light IL passing through the optical unit 110 and the passage portion enters the incident optical unit 150 (see FIG. 4).

Examples of the material of the fixing unit 120 include a metal, an alloy, and a resin.

The fixing unit 120 includes a housing space surrounded by the bottom wall portion 121 and three side wall portions 122-1, 122-2, and 122-3 (see FIGS. 1 and 3). This housing space houses a portion of one end side of the light guide plate unit 100 and a soft resin sheet 142 of the cap unit 140, which will be described later.

The positioning structure 127 positions the light guide plate unit 100 and the optical unit 110. Specifically, the positioning structure 127 positions the light guide plate unit 100 and the optical unit 110 in a direction orthogonal to an optical axis direction OAD (light incident direction from the optical unit 110 to the light guide plate unit 100 (see FIG. 2)) and a direction of rotation around the optical axis direction OAD. Here, the optical axis direction OAD substantially coincides with the optical axis direction of the lens 113 (see FIG. 4) of the optical unit 110.

An allowable position deviation in each of those directions between the light guide plate unit 100 and the optical unit 110 is desirably 40 μm or less.

The positioning structure 127 has a plurality of pins (e.g., first and second pins 130-1 and 130-2) that penetrates the light guide plate 101. Each pin is a rod-like member.

Here, the casing 110H of the optical unit 110 has first insertion holes 110a1 and 110a2 that serve as the reference for the above-mentioned positioning. The light guide plate 101 has a plurality of (e.g., two) first through-holes 100a1 and 100a2 for the above-mentioned positioning. The cover plate 102 has a plurality of (e.g., two) second insertion holes 102a1 and 102a2. The fixing unit 120 has a plurality of (e.g., two) second through-holes 120a1 and 120a2. The first through-hole 100al, the second through-hole 120a1, the first insertion hole 110al, and the second insertion hole 102a1 are located on the same axis. The first through-hole 100a2, the second through-hole 120a2, the first insertion hole 110a2, and the second insertion hole 102a2 are located on the same axis.

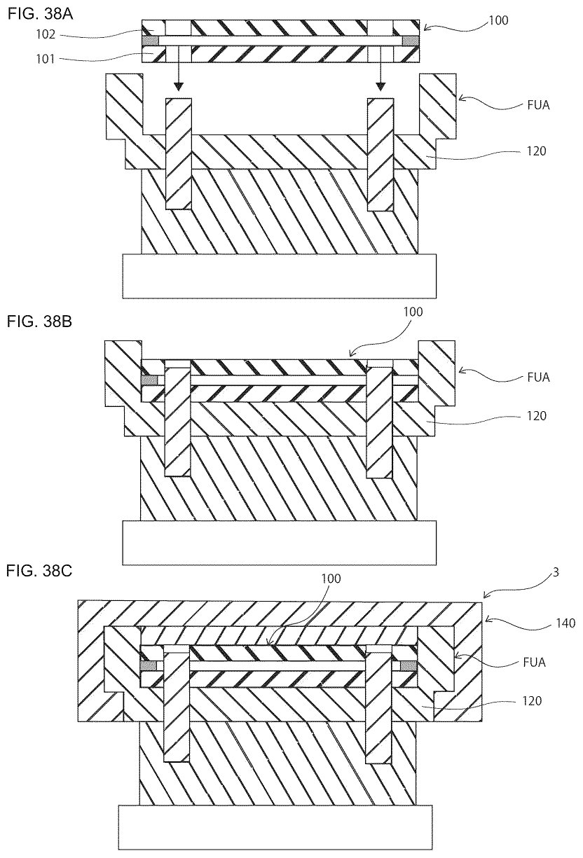

It should be noted that although the second insertion holes 102a1 and 102a2 do not penetrate the cover plate 102 here, the second insertion holes 102a1 and 102a2 may penetrate the cover plate 102 (see FIG. 38).

Each of the first and second pins 130-1 and 130-2 has a circular cross-section orthogonal to its longitudinal direction, for example. Each pin is, for example, made of a resin, a metal, or an alloy.

The first pin 130-1 penetrates first and second through-holes 101a1 and 120al.

A portion of the first pin 130-1 that is on one end side protruding from the light guide plate 101 penetrates the second through-hole 120a1 and a portion of the first pin 130-1 that is on one end side protruding from the fixing unit 120 is inserted in the first insertion hole 110al. The first pin 130-1 may be fixed to the first insertion hole 110a1 or does not need to be fixed to the first insertion hole 110al. In a case where the first pin 130-1 is not fixed to the first insertion hole 110al, the first pin 130-1 is favorably fixed to the second through-hole 120a1 with an adhesion or the like.

A portion of the first pin 130-1 that is on the other end side protruding from the light guide plate 101 is inserted in the second insertion hole 102a1.

The longitudinal direction of the first pin 130-1 is substantially parallel to the optical axis direction OAD in a state in which the portion on the one end side protruding from the light guide plate 101 is inserted in the optical unit 110 (see FIG. 2).

As an example, a first tolerance that is a tolerance (fitting tolerance) between the first pin 130-1 and the first insertion hole 110a1 is set to be extremely small.

As an example, a second tolerance that is a tolerance (fitting tolerance) between the first pin 130-1 and the first through-hole 101a1 is set to be relatively small (equal to or larger than the first tolerance).

As an example, a third tolerance that is a tolerance (fitting tolerance) between the first pin 130-1 and the second through-hole 120a1 is set to be relatively large (larger than each of the first and second tolerances).

As an example, a fourth tolerance that is a tolerance (fitting tolerance) between the first pin 130-1 and the second insertion hole 102a1 is set to be relatively large (larger than each of the first and second tolerances).

The second pin 130-2 penetrates the first and second through-holes 101a2 and 120a2.

A portion of the second pin 130-2 that is on one end side protruding from the light guide plate 101 penetrates the second through-hole 120a2 and a portion of the second pin 130-2 that is on one end side protruding from the fixing unit 120 is inserted in the first insertion hole 110a2. The second pin 130-2 may be fixed to the first insertion hole 110a2 or does not need to be fixed to the first insertion hole 110a2. In a case where the second pin 130-2 is not fixed to the first insertion hole 110a2, the second pin 130-2 is favorably fixed to the second through-hole 120a2 with an adhesion or the like.

A portion of the second pin 130-2 that is on the other end side protruding from the light guide plate 101 is inserted in the second insertion hole 102a2.

The longitudinal direction of the second pin 130-2 is substantially parallel to the optical axis direction OAD in a state in which the portion on the one end side protruding from the light guide plate 101 is inserted in the optical unit 110 (see FIG. 2).

As an example, a fifth tolerance that is a tolerance (fitting tolerance) between the second pin 130-2 and the first insertion hole 110a2 is set to be extremely small.

As an example, a sixth tolerance that is a tolerance (fitting tolerance) between the second pin 130-2 and the first through-hole 101a2 is set to be relatively large (larger than the fifth tolerance) in consideration of expansion/contraction of the light guide plate material due to a change in temperature.

As an example, a tolerance (fitting tolerance) between the first pin 130-1 and the second through-hole 120a2 is set to be relatively large (larger than at least the fifth tolerance of the fifth and sixth tolerances).

As an example, a tolerance (fitting tolerance) between the first pin 130-1 and the second insertion hole 102a2 is set to be relatively large (larger than at least the fifth tolerance of the fifth and sixth tolerances).

The light guide plate unit 100 has, as shown in FIG. 3, two first fitting portions 100b1 and 100b2 that substantially fit to the fixing unit 120. The fixing unit 120 includes a second fitting portion 120b1 and a second fitting portion 120b2. The second fitting portion 120b1 substantially fits to the first fitting portion 100b1. The second fitting portion 120b2 substantially fits to the first fitting portion 100b2.

A plurality of sets (e.g., two sets) of the first and second fitting portions that substantially fit to each other is provided and first and second fitting portions of at least two sets (e.g., two sets) of the plurality of sets are different from each other in fitting shape. To be specific, the set of the first and second fitting portions 100b1 and 120b1 that substantially fit to each other and the set of the first and second fitting portions 100b2 and 120b2 that substantially fit to each other are different from each other in fitting shape. As an example, the first fitting portions 100b1 and 100b2 are cutouts different in shape. The second fitting portion 120b1 is a convex portion that has a shape corresponding to the cutout shape of the first fitting portion 100b1 and enters the cutout. The second fitting portion 120b2 is a convex portion that has a shape corresponding to the cutout shape of the first fitting portion 100b2 and enters the cutout.

Since the first and second fitting portions of the respective sets are different in fitting shape, the light guide plate unit 100 can be set to the fixing unit 120 (the light guide plate unit 100 cannot be set to the fixing unit 120 if the light guide plate unit 100 is upside down) in such a manner that the front and back sides of the light guide plate unit 100 become in a predetermined orientation (orientation in which the incident optical unit 150 is located at an appropriate position with respect to the optical unit 110 and the emission optical unit 160 is positioned at an appropriate position with respect to the eyeball of the user). It should be noted that if the light guide plate 101 is set to the fixing unit 120 in such a manner that the front and back sides of the light guide plate 101 become in an orientation opposite to the predetermined orientation, the positions of the incident optical unit 150 and the emission optical unit 160 are inverted with respect to the appropriate positions. As a result, the image light cannot be guided to the eyeball of the user in accordance with the optical design.

The light guide plate unit 100 has corner portions housed in the fixing unit 120, which are significantly chamfered, such that it is free from the fixing unit 120 (see FIG. 3).

As shown in FIGS. 1 and 5, the cap unit 140 covers the light guide plate unit 100 from at least a side opposite to the side of the optical unit 110.

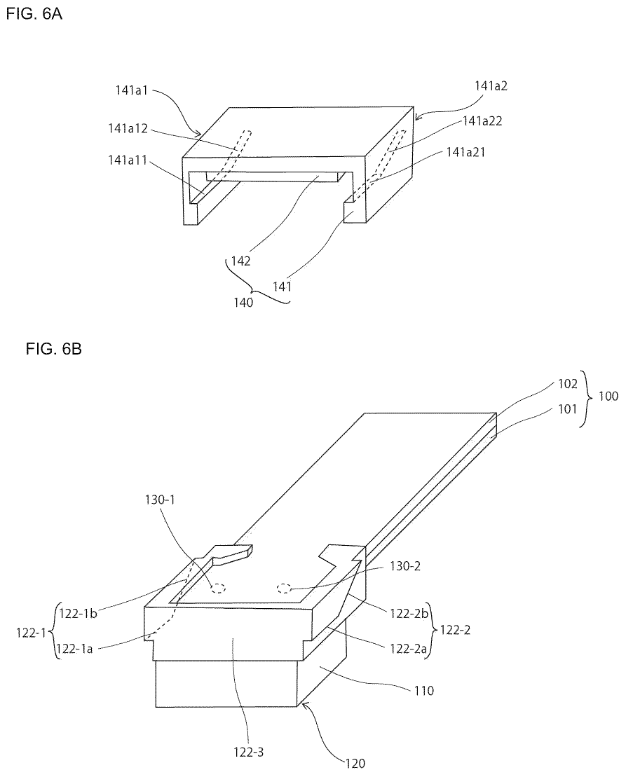

A of FIG. 6 is a perspective view of the cap unit 140. B of FIG. 6 is a perspective view showing a state in which the cap unit 140 has been detached from the optical apparatus 10.

As an example, as shown in A of FIG. 6 and B of FIG. 6, the cap unit 140 includes a cap member 141 and the soft resin sheet 142. The cap member 141 is attachable and detachable to/from the fixing unit 120. The soft resin sheet 142 is disposed between the cap member 141 and the light guide plate unit 100.

Examples of the material of the cap member 141 include a metal, an alloy, and a hard resin.

The material of the soft resin sheet 142 can be, for example, a soft resin such as rubber, silicone, and elastomer.

The cap unit 140 enables attachment and detachment of the cap member 141 by sliding the cap member 141 with respect to the fixing unit 120 (see FIG. 4). Here, the cap member 141 is attachable and detachable by sliding with respect to the fixing unit 120 in the arrow directions in FIG. 4.

The cap member 141 has such a fitting shape that it slidably fits onto the fixing unit 120 as shown in FIG. 1. To be specific, the cap member 141 has a substantially C-shaped cross-section and the fixing unit 120 has a cross-section shaped so as to fit in the cap member 141.

More particularly, the pair of side wall portions 122-1 and 122-2 of the fixing unit 120, which are opposite to each other, are respectively fitted in a pair of side wall portions 141a1 and 141a2 of the cap member 141, which are opposite to each other.

As shown in B of FIG. 6, the side wall portion 122-1 of the fixing unit 120 includes a slide portion 122-la and a tilt portion 122-1b. The slide portion 122-la is located on a side of the side wall portion 122-3 and is substantially parallel to the light guide plate 101. The tilt portion 122-1b is located on a side opposite to the side of the side wall portion 122-3 and is tilted with respect to the light guide plate 101.

As shown in A of FIG. 6, the side wall portion 141a1 of the cap member 141 includes a slide portion 141a11 and a tilt portion 141a12. The slide portion 141a11 is substantially parallel to the light guide plate 101 and is slidable with the slide portion 122-la of the fixing unit 120. The tilt portion 141a12 faces the tilt portion 122-1b of the fixing unit 120 and has the same tilt direction and the same tilt angle as the tilt portion 122-1b.

As shown in B of FIG. 6, the side wall portion 122-2 of the fixing unit 120 includes a slide portion 122-2a and a tilt portion 122-2b. The slide portion 122-2a is located on the side of the side wall portion 122-3 and is substantially parallel to the light guide plate 101. The tilt portion 122-2b is located on the side opposite to the side of the side wall portion 122-3 and is tilted with respect to the light guide plate 101.

As shown in A of FIG. 6, the side wall portion 141a2 of the cap member 141 includes a slide portion 141a21 and a tilt portion 141a22. The slide portion 141a21 is substantially parallel to the light guide plate 101 and is slidable with the slide portion 122-2a of the fixing unit 120. The tilt portion 141a22 faces the tilt portion 122-2b of the fixing unit 120 and has the same tilt direction and the same tilt angle as the tilt portion 122-1b.

Hereinafter, a method of mounting the cap unit 140 to the fixing unit 120 will be briefly described.

First of all, an end portion of the light guide plate unit 100 in the state in B of FIG. 6 that is on a side opposite to a side of the fixing unit 120 is inserted in the cap unit 140, the cap unit 140 is slid to the side of the fixing unit 120 along the light guide plate unit 100, and the cap unit 140 is slid to the side of the side wall portion 122-3 of the fixing unit 120 while the cap unit 140 is being fitted onto the fixing unit 120. Then, when the tilt portions of the cap unit 140 are respectively brought into contact with the corresponding tilt portions of the fixing unit 120, the cap unit 140 is disabled to slide to the side of the side wall portion 122-3 (but slidable to the side opposite to the side of the side wall portion 122-3). At this time, mounting of the cap unit 140 to the fixing unit 120 is completed. At this time, the soft resin sheet 142 of the cap unit 140 is held in close contact with the light guide plate unit 100 and a state in which the cap unit 140 pushes the light guide plate unit 100 against the fixing unit 120 is obtained.

It should be noted that the user can detach the cap unit 140 from the fixing unit 120 by executing a process opposite to the above-mentioned mounting method.

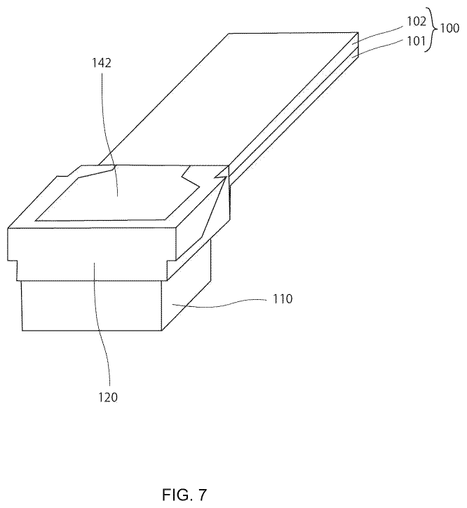

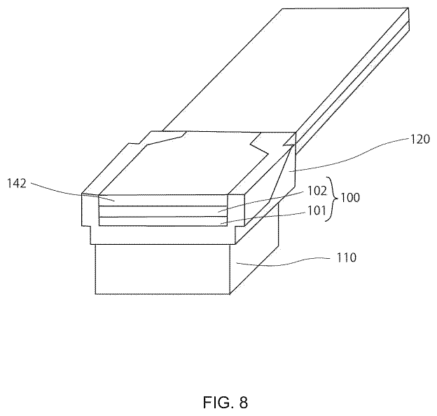

FIG. 7 is a perspective view showing a state in which the cap member 141 of the cap unit 140 has been removed from the optical apparatus 10. FIG. 8 is a perspective view showing a state in which the interior of the fixing unit 120 has been exposed by removing the cap member 141 from the optical apparatus 10 and removing one side wall portion (side wall portion 122-3) of the fixing unit 120. As shown in FIGS. 7 and 8, the light guide plate 101, the cover plate 102, and the soft resin sheet 142 are arranged inside the fixing unit 120 (inside the housing space) in the stated order from the side of the optical unit 110. The soft resin sheet 142 has an outer shape along an inner wall surface of the fixing unit 120, for example.

In a state in which the cap unit 140 has been mounted to the fixing unit 120, the soft resin sheet 142 pushes the light guide plate unit 100 towards the fixing unit 120. This can suppress rattling of the light guide plate unit 100.

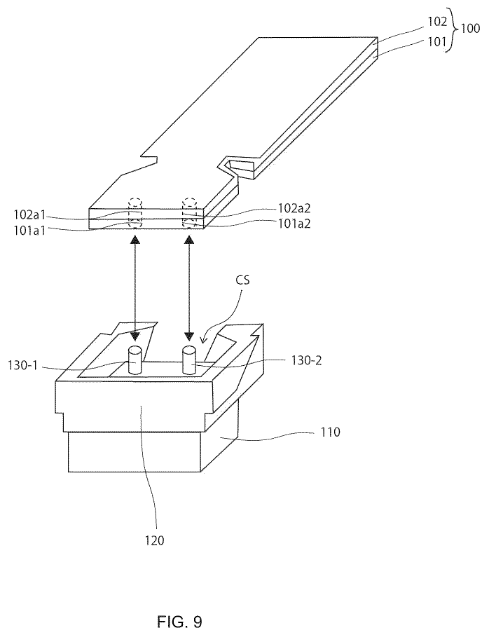

FIG. 9 is a perspective view showing a state in which the light guide plate unit 100 is attached and detached to/from the fixing unit 120. As shown in FIG. 9, the light guide plate unit 100 is attached and detached to/from the fixing unit 120 in a state in which the first through-hole 101a1 of the light guide plate 101 and the second insertion hole 102a1 of the cover plate 102 are aligned with the first pin 130-1 that is inserted in the optical unit 110 and penetrates the fixing unit 120 and in which the second through-hole 101a2 of the light guide plate 101 and the second insertion hole 102a2 of the cover plate 102 are aligned with the second pin 130-2 that is inserted in the optical unit 110 and penetrates the fixing unit 120.

### (2) Manufacturing Method for Light Guide Plate Unit

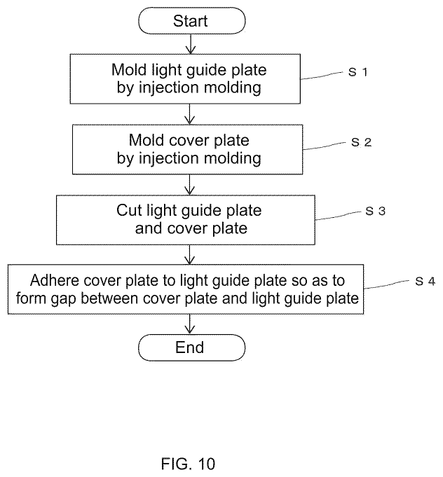

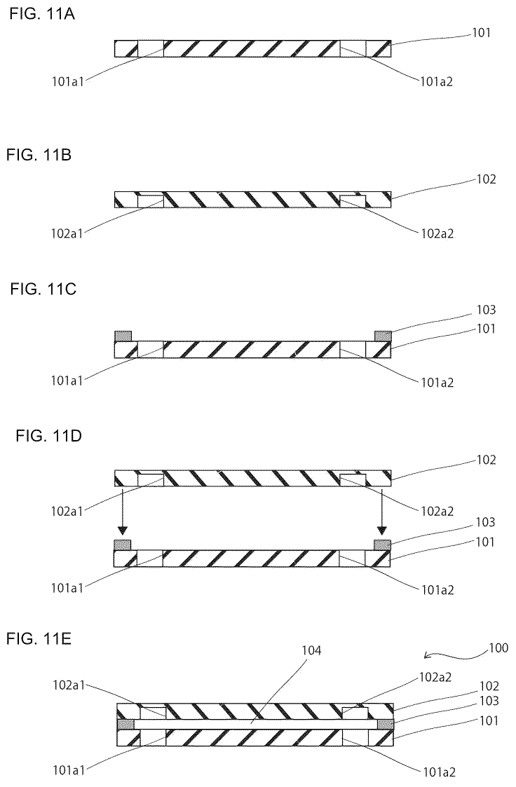

Hereinafter, a manufacturing method for the light guide plate unit 100 will be described with reference to the flowchart in FIG. 10 and the cross-sectional views in A of FIG. 11 to E of FIG. 11.

In initial Step S1, the light guide plate 101 is molded by for example injection molding. Specifically, the light guide plate 101 is molded to have the two first through-holes 101a1 and 101a2 formed therein by injection molding (see A of FIG. 11).

In next Step S2, the cover plate 102 is molded by for example injection molding. Specifically, the cover plate 102 is molded to have the two second insertion holes 102a1 and 102a2 formed therein by injection molding (see B of FIG. 11).

In next Step S3, the light guide plate 101 and the cover plate 102 are cut, for example. Specifically, cutouts that are the first fitting portions 100b1 and 100b2 are formed in the light guide plate 101 and the cover plate 102 (see FIG. 3).

In last Step S4, the cover plate 102 is adhered to the light guide plate 101 so as to form the gap 104 between the cover plate 102 and the light guide plate 101.

Specifically, first of all, an adhesion 103 is applied to outer edge portions of the light guide plate 101 (see C of FIG. 11). Subsequently, the cover plate 102 is bonded to the light guide plate 101 via the adhesion 103 in a state in which alignment is performed so that the second insertion hole 102a1 is on the same axis as the first through-hole 101a1 of the light guide plate 101 and the second insertion hole 102a2 is on the same axis as the first through-hole 101a2 of the light guide plate 101 (see D of FIG. 11). As a result, the light guide plate unit 100 with the gap 104 formed between the light guide plate 101 and the cover plate 102 is generated (see E of FIG. 11).

It should be noted that in FIG. 10, the order of Steps S1 and S2 may be inverted.

### (3) Manufacturing Method for Cap Unit

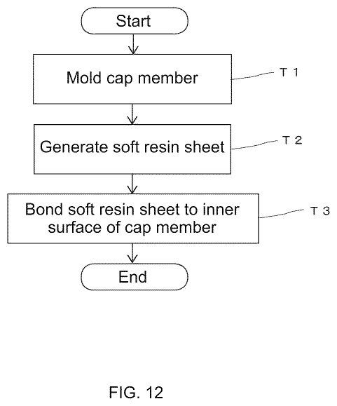

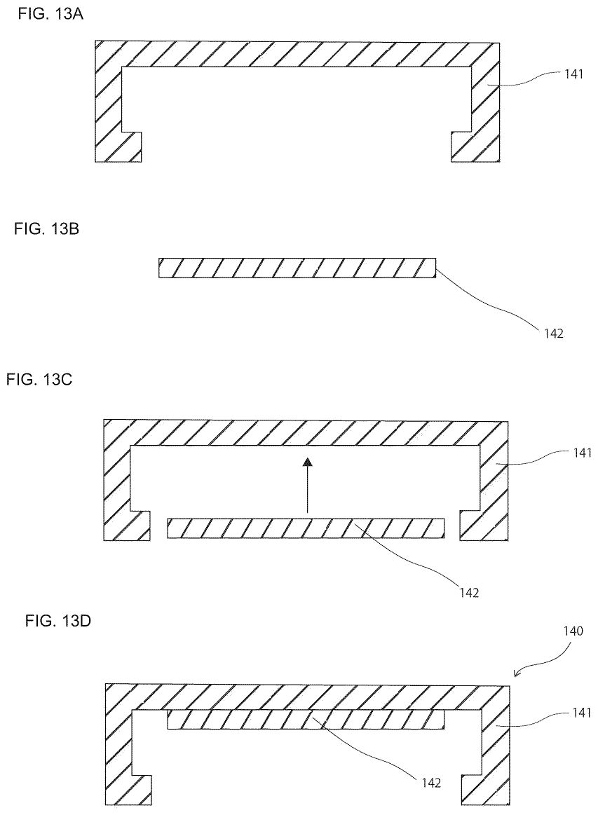

Hereinafter, a manufacturing method for the cap unit 140 will be described with reference to the flowchart in FIG. 12 and the cross-sectional views in A of FIG. 13 to D of FIG. 13.

In first Step T1, the cap member 141 is molded. Specifically, in a case where the cap member 141 is made of a metal or an alloy, it is molded by sheet metal processing, and in a case where the cap member 141 is made of a resin, it is molded by injection molding. In either case, the cap member 141 is molded to have a substantially C-shaped cross-section (see A of FIG. 13).

In next Step T2, the soft resin sheet 142 is generated. Specifically, the soft resin sheet 142 is generated by molding the soft resin material into a sheet-shape (see B of FIG. 13).

In last Step T3, the soft resin sheet 142 is bonded to an inner surface of the cap member 141 (see C of FIG. 13). Specifically, the soft resin sheet 142 is adhered to the inner surface of the cap member 141 with an adhesion or the like. As a result, the cap unit 140 with the soft resin sheet 142 bonded to the inner surface of the cap member 141 is completed (see D of FIG. 13).

It should be noted that in FIG. 12, the order of Steps T1 and T2 may be inverted.

### (4) Manufacturing Method for Fixing Unit Assembly

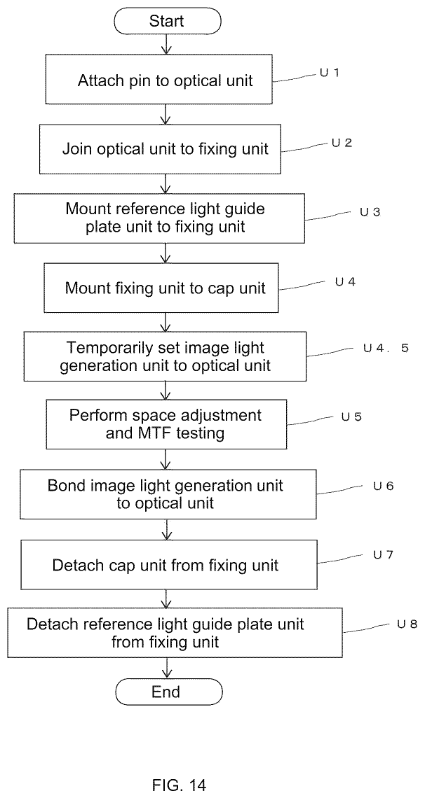

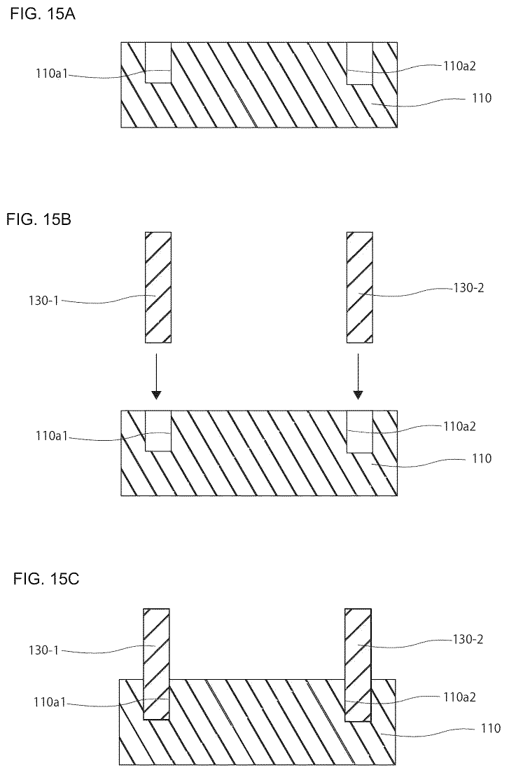

Hereinafter, a manufacturing method for a fixing unit assembly FUA will be described with reference to the flowchart in FIG. 14 and the cross-sectional views in A of FIG. 15 to FIG. 20. The fixing unit assembly FUA is an assembly including the fixing unit 120, the optical unit 110, and the first and second pins 130-1 and 130-2. The assembly enables the user to easily disassemble and assemble the image display apparatus 1 when replacing the light guide plate 101.

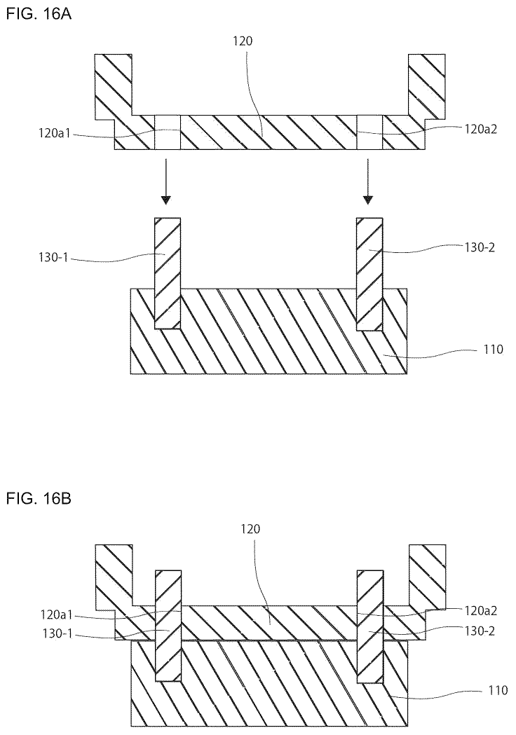

Here, the optical unit 110 has already been molded to have the two first insertion holes 110a1 and 110a2 formed therein by injection molding (see A of FIG. 15) and the fixing unit 120 has already been molded to have the two second through-holes 120a1 and 120a2 formed therein by sheet metal processing or injection molding (see A of FIG. 16).

In first Step U1, the pins are attached to the optical unit 110. Specifically, the first pin 130-1 is inserted in the first insertion hole 110a1 of the optical unit 110 and the second pin 130-2 is inserted in the first insertion hole 110a2 (B of FIG. 15, see C of FIG. 15). The pins may be respectively fixed to the corresponding first insertion holes via for example an adhesion or do not need to be fixed thereto.

In next Step U2, the fixing unit 120 is joined to the optical unit 110. Specifically, an adhesion is applied to a surface of the fixing unit 120 that is joined to the optical unit 110 and/or a surface of the optical unit 110 that is joined to the fixing unit 120, the fixing unit 120 is aligned with the optical unit 110 (see A of FIG. 16), and then, the fixing unit 120 is joined to the optical unit 110 by causing the first pin 130-1 to penetrate the second through-hole 120a1 and causing the second pin 130-2 to penetrate the second through-hole 120a2 (see B of FIG. 16).

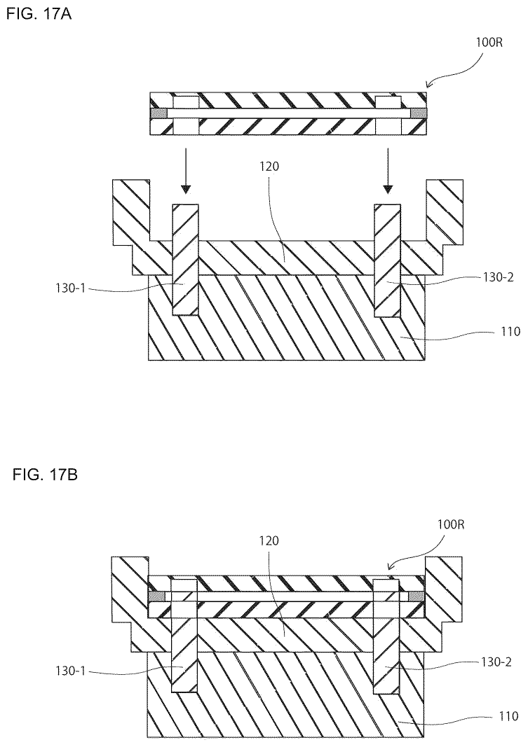

In next Step U3, a reference light guide plate unit 100R (light guide plate unit for adjustment of assembling, which is substantially the same as the light guide plate unit 100) is mounted to the fixing unit 120. Specifically, the reference light guide plate unit 100R is aligned with the fixing unit 120 (see A of FIG. 17), and then the reference light guide plate unit 100R is placed on the fixing unit 120 by causing the corresponding pins to respectively penetrate and be inserted in the through-hole and insertion hole of the reference light guide plate unit 100R, which are positioned on the same axis (see B of FIG. 17).

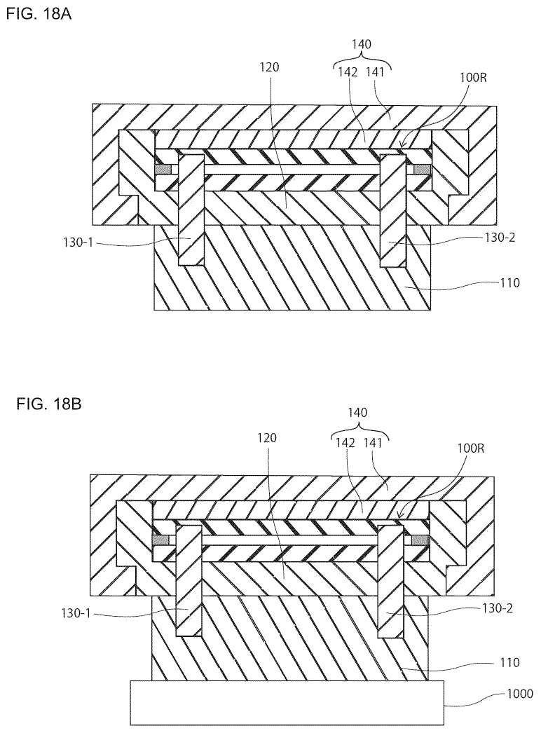

In next Step U4, the cap unit 140 is mounted to the fixing unit 120. Specifically, an end portion of the reference light guide plate unit 100R that is on the side opposite to the side of the side wall portion 122-3 of the fixing unit 120 is inserted in the cap unit 140, the cap unit 140 is slid to the side of the side wall portion 122-3 along the reference light guide plate unit 100R, and the cap unit 140 is further slid while the cap unit 140 is being fitted onto the fixing unit 120. In this manner, the cap unit 140 is mounted to the fixing unit 120 (see A of FIG. 18).

In next Step S4.5, the image light generation unit 1000 is temporarily set to the optical unit 110.

In next Step U5, space adjustment and modulation transfer function (MTF) testing are performed. Specifically, space adjustment and MTF testing are performed while moving the image generation unit 1000 temporarily set to the optical unit 110 and alignment is performed as it is designed.

In next Step U6, the image light generation unit 1000 is bonded to the optical unit 110. Specifically, the image light generation unit 1000 is bonded to a surface (incident surface) of the optical unit 110 that is on a side opposite to the side of the fixing unit 120 with an adhesion or the like so that a final positional relationship in Step U5 is maintained (see B of FIG. 18).

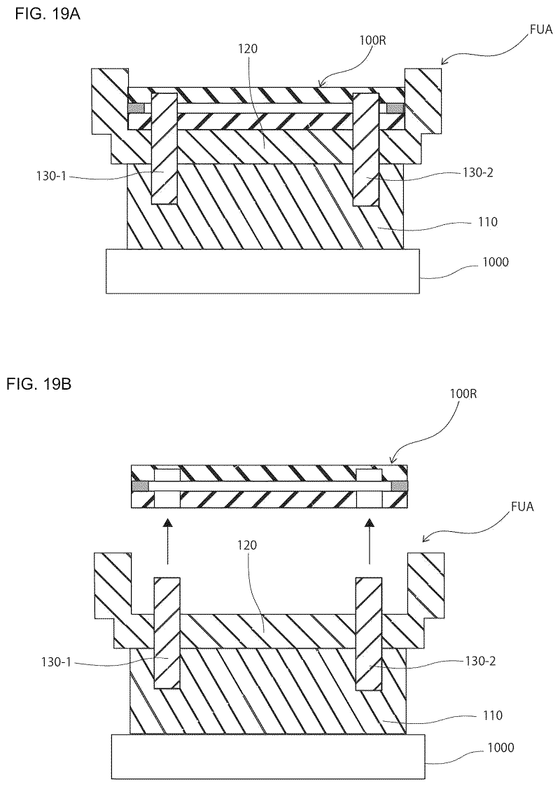

In next Step U7, the cap unit 140 is detached from the fixing unit 120. Specifically, the cap unit 140 is detached from the fixing unit 120 by a process opposite to Step U4 (see A of FIG. 19). Accordingly, the fixing unit assembly FUA constituted by the fixing unit 120, the optical unit 110, the first and second pins 130-1 and 130-2, and the image light generation unit 1000 is completed.

It should be noted that the cap unit 140 used for manufacturing the fixing unit assembly FUA is favorably used in combination with the fixing unit assembly FUA when assembling the image display apparatus 1.

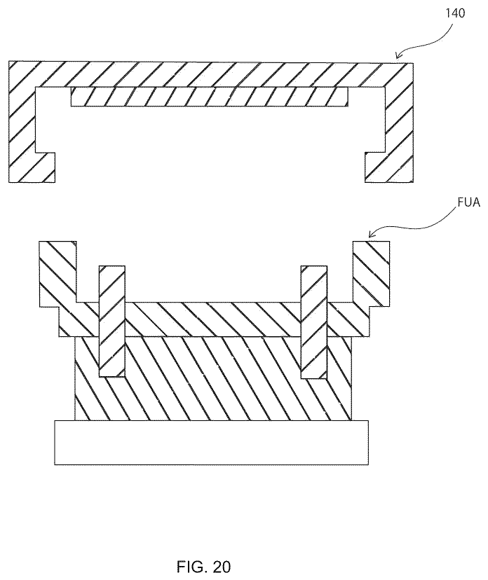

In last Step U8, the reference light guide plate unit 100R is detached. Specifically, the reference light guide plate unit 100R is detached from the fixing unit 120 of the fixing unit assembly FUA (see B of FIG. 19). As a result, the fixing unit assembly FUA and the cap unit 140 used for assembling the image display apparatus 1 are prepared (see FIG. 20).

### (5) Assembling Method for Image Display Apparatus

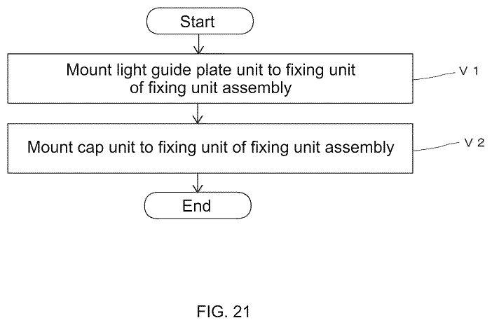

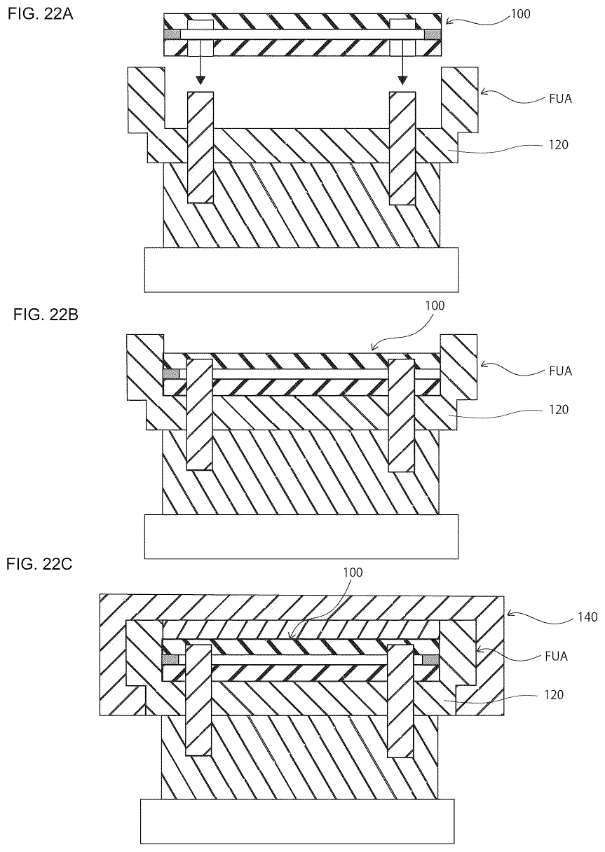

Hereinafter, an assembling method for the image display apparatus 1 will be described with reference to the flowchart in FIG. 21 and the cross-sectional views in A of FIG. 22 to C of FIG. 22. The user assembles the image display apparatus 1 for example when the user replaces the light guide plate unit 100.

In first Step V1, for example, the user mounts the light guide plate unit 100 to the fixing unit 120 of the fixing unit assembly FUA. Specifically, the light guide plate unit 100 is aligned with the fixing unit 120 (see A of FIG. 22), and then the light guide plate unit 100 is placed on the fixing unit 120 by causing the corresponding pins to respectively penetrate and be inserted in the through-hole and insertion hole of the light guide plate unit 100, which are positioned on the same axis (see B of FIG. 22).

In last Step V2, for example, the user mounts the cap unit 140 to the fixing unit 120 of the fixing unit assembly FUA. Specifically, an end portion of the light guide plate unit 100 that is on the side opposite to the side of the side wall portion 122-3 of the fixing unit 120 is inserted in the cap unit 140, the cap unit 140 is slid to the side of the side wall portion 122-3 along the light guide plate unit 100, and the cap unit 140 is further slid while the cap unit 140 is being fitted onto the fixing unit 120. In this manner, the cap unit 140 is mounted to the fixing unit 120 (see C of FIG. 22). As a result, the image display apparatus 1 is completed.

It should be noted that the image display apparatus 1 can be disassembled by a process opposite to the above-mentioned assembling method.

That is, since the image display apparatus 1 is constituted by the light guide plate unit 100, the fixing unit assembly FUA, and the cap unit 140, the user can extremely easily assemble and disassemble the image display apparatus 1 when the user replaces the light guide plate unit 100.

### (6) Effects of Optical Apparatus and Image Display Apparatus

The optical apparatus 10 according to the first embodiment of the present technology includes the light guide plate unit 100 including the light guide plate 101, the optical unit 110 that guides incident light to the light guide plate unit 100, and the fixing mechanism 125 that detachably fixes the light guide plate unit 100 to the optical unit 110.

In this case, the user can replace the light guide plate unit 100.

The optical apparatus 10 according to the first embodiment of the present technology can provide the optical apparatus 10 in which different light guide plate units 100 can be used.

The fixing mechanism 125 includes the positioning structure 127 that positions the light guide plate unit 100 and the optical unit 110. This can achieve optical alignment between the light guide plate unit 100 and the optical unit 110.

The positioning structure 127 includes the first and second pins 130-1 and 130-2 that penetrate the light guide plate 101. Moreover, the portions of the first and second pins 130-1 and 130-2 that are on the one end side protruding from the light guide plate 101, are inserted in the optical unit 110. This enables the light guide plate unit 100 and the optical unit 110 to be positioned with a simple structure.

The fixing mechanism 125 includes the fixing unit 120 and the cap unit 140. At least a portion (bottom wall portion 121) of the fixing unit 120 is located between the light guide plate unit 100 and the optical unit 110. The fixing unit 120 is fixed to the optical unit 110. The cap unit 140 covers the light guide plate unit 100 from at least a side opposite to the side of the optical unit 110. The cap unit 140 includes the cap member 141 attachable and detachable to/from the fixing unit 120. The first and second pins 130-1 and 130-2 penetrate the light guide plate 101 and the bottom wall portion 121 of the fixing unit 120.

The cap member 141 is attachable and detachable to/from by sliding with respect to the fixing unit 120. Accordingly, the cap unit 140 can be easily attached and detached to/from the fixing unit 120.

The cap member 141 slidably fits onto the fixing unit 120. Accordingly, the cap member 141 can be stably and easily attached and detached to/from the fixing unit 120.

The cap unit 140 further includes the soft resin sheet 142 disposed between the cap member 141 and the light guide plate unit 100. This enables the fixing unit 120 to retain the light guide plate unit 100 with no rattle.

The first and second pins 130-1 and 130-2 may be fixed to the fixing unit 120 and do not need to be fixed to the optical unit 110.

The first and second pins 130-1 and 130-2 may be fixed to the optical unit 110. Although steps for manufacturing the optical apparatus 10 increase, this suppresses drop of the pins when the user replaces the light guide plate unit 100. Therefore, the pins are prevented from being lost, for example.

The light guide plate unit 100 further includes the cover plate 102 arranged so as to form the gap with respect to the light guide plate 101. Accordingly, the light guide plate 101 can be protected without interfering with light propagation due to total internal reflection in the light guide plate 101.

Portions of the first and second pins 130-1 and 130-2 that are on the other end side protruding from the light guide plate 101 are inserted in the cover plate 102. Accordingly, the cover plate 102 can protect the light guide plate 101 and the cover plate 102 can press the portions of the respective pins that are on the other end side of penetrating the light guide plate 101.

The light guide plate unit 100 includes the first fitting portions 100b1 and 100b2 that substantially fit to the fixing unit 120 and the fixing unit 120 has the second fitting portions 120b1 and 120b2 that respectively substantially fit to the first fitting portions 100b1 and 100b2. This enables the fixing unit 120 to stably retain the light guide plate unit 100.

A plurality of sets of the first and second fitting portions that substantially fit to each other is provided and the first and second fitting portions (e.g., the first and second fitting portions 100b1 and 120b1, the first and second fitting portions 100b2 and 120b2) of at least two sets of the plurality of sets are different in shape. Accordingly, when replacing the light guide plate unit 100, the user can place the light guide plate unit 100 on the fixing unit 120 in such a manner that the front and back sides of the light guide plate unit 100 become in the predetermined orientation.

The first fitting portions 100b1 and 100b2 are cutouts. The second fitting portions 120b1 and 120b2 are convex portions that have shapes corresponding to the shapes of those cutouts and enter those cutouts. This enables the user to recognize the front and back sides of the light guide plate 101 at a glance.

At least one pin (e.g., the first and second pins 130-1 and 130-2) is a plurality of pins. This enables positioning of the light guide plate unit 100 and the optical unit 110 in the direction orthogonal to the optical axis direction OAD and the direction of rotation around the optical axis direction OAD to be performed with a high accuracy.

The image display apparatus 1 includes the optical apparatus 10 and the image light generation unit 1000 that causes the image light IL to enter the optical unit 110 of the optical apparatus 10. Moreover, the image display apparatus 1 causes the image light IL that has passed through the light guide plate unit 100 of the optical apparatus 10 to enter the eyeball EB of the user. This can provide the image display apparatus 1 excellent in utility that enables replacement of the light guide plate unit 100.

The image light generation unit 1000 is mounted to the optical unit 110. This enables unitization of the image display apparatus 1.

In accordance with the image display apparatus 1 including the optical apparatus 10, the user can easily replace the light guide plate unit 100. Therefore, the user can immediately replace the light guide plate unit 100 by a new one for displaying a favorable image, for example, in a case where the light guide plate unit 100 is damaged. Moreover, the user can immediately change the light guide plate unit 100 into the light guide plate unit 100 with a different design, for example, in a case where the user wishes to change the design of the light guide plate unit 100.

The light guide plate unit 100 favorably includes the incident optical unit 150 that causes the image light IL passing through the optical unit 110 to enter the light guide plate 101 and the emission optical unit 160 that emits the image light IL that has propagated inside the light guide plate 101 towards the eyeball EB.

### 3. Optical Apparatus According to Second Embodiment of Present Technology and Image Display Apparatus Including Optical Apparatus

### (1) Configurations of Optical Apparatus and Image Display Apparatus

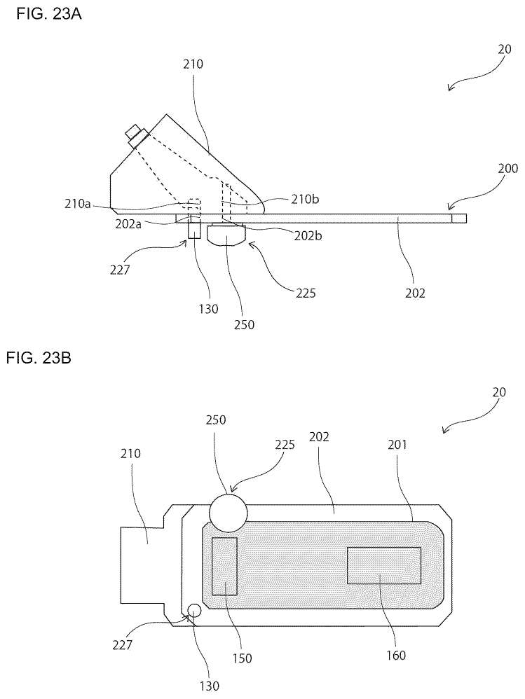

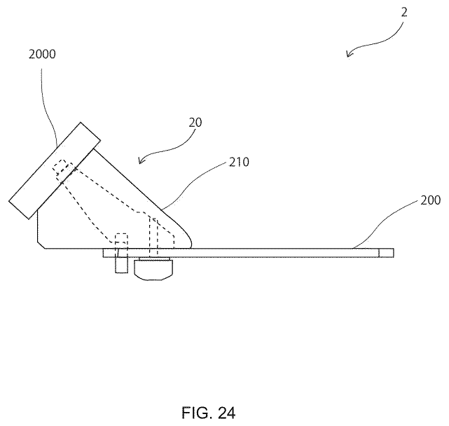

Hereinafter, an optical apparatus according to a second embodiment of the present technology and an image display apparatus including the optical apparatus will be described with reference to A of FIG. 23, B of FIG. 23, and FIG. 24.

A of FIG. 23 is a side view of an optical apparatus 20 according to the second embodiment. B of FIG. 23 is a bottom view of the optical apparatus 20 according to the second embodiment.

A light guide plate unit 200 of the optical apparatus 20 according to the second embodiment integrally includes, as shown in A of FIG. 23 and B of FIG. 23, a light guide plate 201 and a frame-like member 202 in which the light guide plate 201 is fitted on its inner peripheral side. The frame-like member 202 is made of, for example, a resin, a glass, a metal, or an alloy. It should be noted that the frame-like member 202 may be a portion of an eyeglass frame as the above-mentioned support structure.

As to a fixing mechanism 225 of the optical apparatus 20, a positioning structure 227 has a pin 130.

The pin 130 is inserted in an insertion hole 210a formed in an optical unit 210 (e.g., a prism lens unit). For example, the pin 130 is fixed with an adhesion or the like.

A portion on one end side of the light guide plate 201 fitted in the frame-like member 202 is pushed against the optical unit 210 together with the frame-like member 202.

The pin 130 penetrates a through-hole 202a formed in the frame-like member 202 pushed against the optical unit 210. The frame-like member 202 is detachably fixed to the optical unit 210 through a fixing member 250. The fixing member 250 is a screw that is threadedly engaged with a threaded hole 210b formed in the optical unit 210. The screw penetrates a through-hole 202b formed in the frame-like member 202 and a portion of the screw, which protrudes from the frame-like member 202 towards the optical unit 210, is threadedly engaged with the threaded hole 210b.

An incident optical unit 150 is provided in the portion on the one end side of the light guide plate 201 that is pushed against the optical unit 210 and an emission optical unit 160 is provided in a portion on the other end side.

In the optical apparatus 20, the pin 130 and the fixing member 250 achieve positioning of the light guide plate 201 and the optical unit 210.

An image display apparatus 2 including the optical apparatus 20 includes, as shown in FIG. 24, the optical apparatus 20 and an image light generation unit 2000 mounted to the optical unit 210 of the optical apparatus 20.

### (2) Assembling Method for Image Display Apparatus

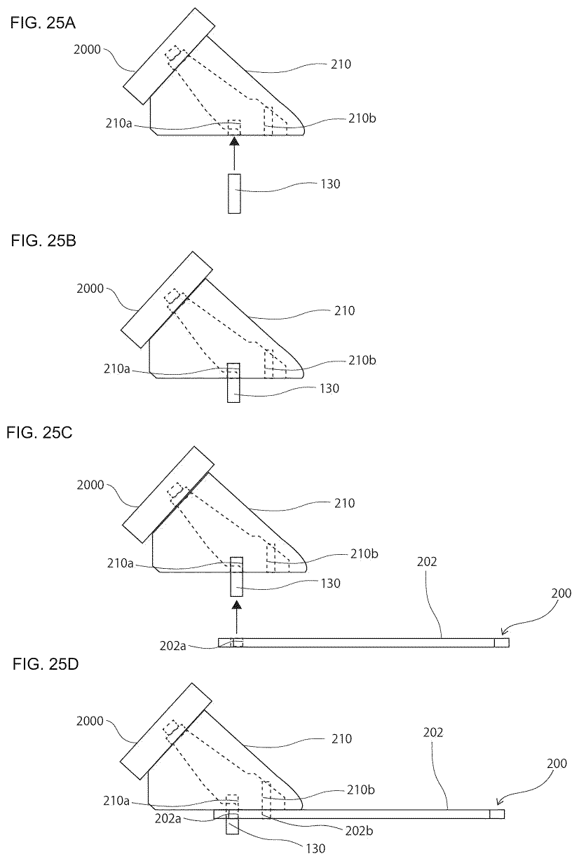

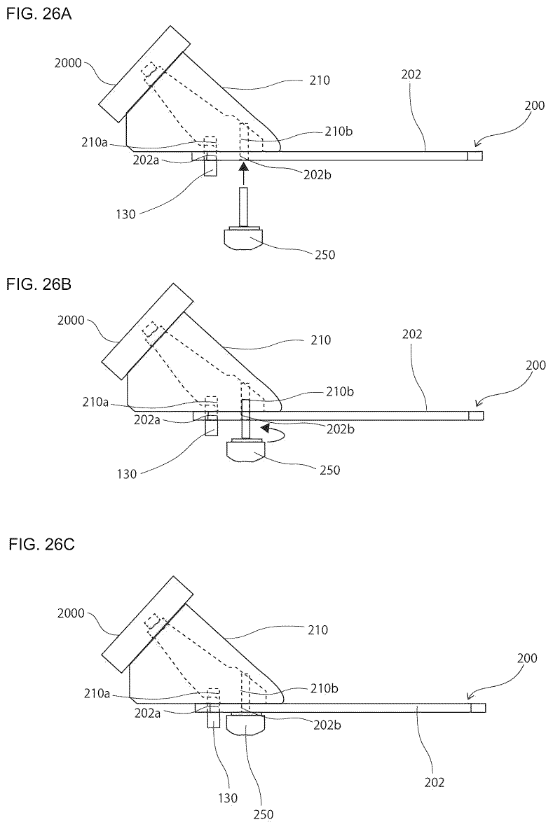

Hereinafter, an assembling method for the image display apparatus 2 will be described with reference to the side views in A of FIG. 25 to D of FIG. 25 and A of FIG. 26 to C of FIG. 26. The user performs this assembling method for example when the user replaces the light guide plate unit 200. Here, the portion on the one end side of the pin 130 has already been inserted in the insertion hole 210a of the optical unit 210 and fixed (e.g., with an adhesion or the like) (A of FIG. 25 and see B of FIG. 25).

First of all, the user aligns the portion of the pin 130 that is on the other end side protruding from the optical unit 210 with the through-hole 202a of the frame-like member 202 (see C of FIG. 25), and inserts the pin 130 into the through-hole 202a and pushes the optical unit 210 against the frame-like member 202 (see D of FIG. 25).

Subsequently, the user aligns the threaded hole 210b formed in the optical unit 210 with the through-hole 202b formed in the frame-like member 202 (see A of FIG. 26) and threadedly engages the screw as the fixing member 250 with the threaded hole 210b via the frame-like member 202 (see B of FIG. 26). When the screw as the fixing member 250 is fastened, mounting of the light guide plate unit 200 on the optical unit 210 is completed (see C of FIG. 26).

It should be noted that the optical apparatus 20 can be disassembled by a process opposite to the above-mentioned assembling method.

### (3) Effects of Optical Apparatus and Image Display Apparatus

With the optical apparatus 20 and the image display apparatus 2, the user can for example extremely easily assemble and disassemble the optical apparatus 20 and the image display apparatus 2 by inserting and fixing the pin 130 to the optical unit 210 in advance as described above.

In accordance with the image display apparatus 2 including the optical apparatus 20, the user can extremely easily replace the light guide plate unit 200. Therefore, the user can immediately replace the light guide plate unit 200 by a new one for displaying a favorable image, for example, in a case where the light guide plate unit 200 is damaged. Moreover, the user can immediately change the light guide plate unit 200 into the light guide plate unit 200 with a different design, for example, in a case where the user wishes to change the design of the light guide plate unit 200.

### 4. Modified Examples of Present Technology

The configurations of the optical apparatus according to each of the above-mentioned embodiments of the present technology and the image display apparatus including the optical apparatus can be modified as appropriate.

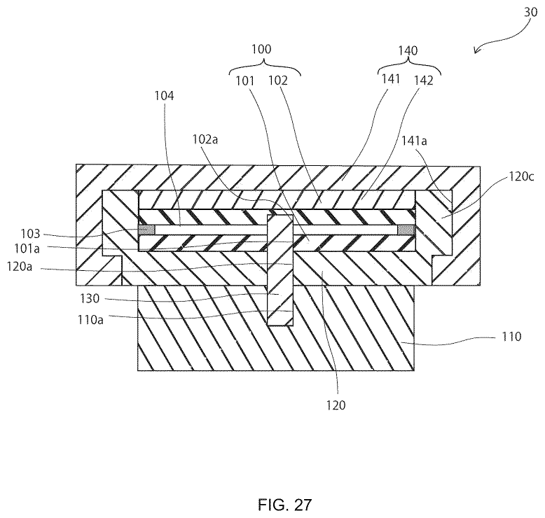

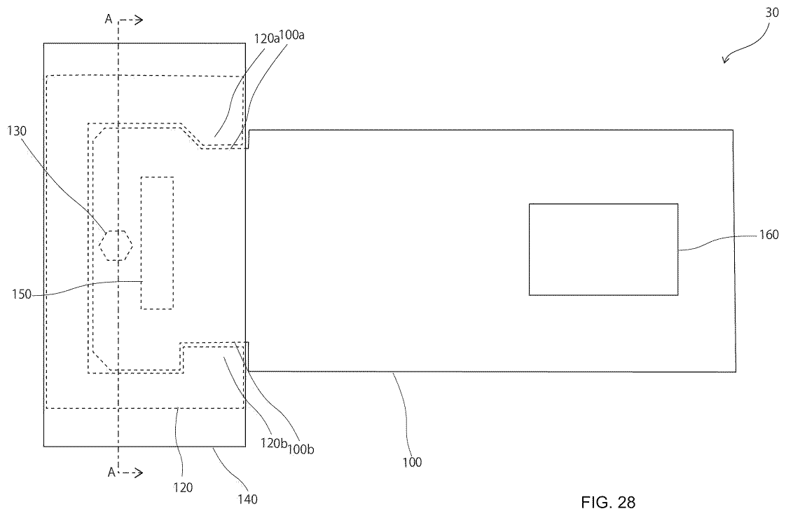

FIG. 27 is a cross-sectional view of an optical apparatus 30 according to Modified Example 1 of the first embodiment. FIG. 28 is a plan view of the optical apparatus 30 according to Modified Example 1 of the first embodiment. FIG. 27 is a cross-sectional view taken along the line A-A in FIG. 28. As shown in FIGS. 27 and 28, the optical apparatus 30 according to Modified Example 1 of the first embodiment includes a single pin 130.

The cross-section shape of the optical apparatus 30, which is orthogonal to a longitudinal direction of the pin 130, is a polygonal shape (e.g., a regular hexagonal shape). A through-hole shape that the pin 130 provided in the light guide plate unit 100 penetrates is also a polygonal shape (e.g., a regular hexagonal shape) in which the pin 130 is fitted. Therefore, the single pin 130 enables positioning of the light guide plate unit 100 and the optical unit 110 in the direction orthogonal to the optical axis direction and the direction of rotation around the optical axis direction.

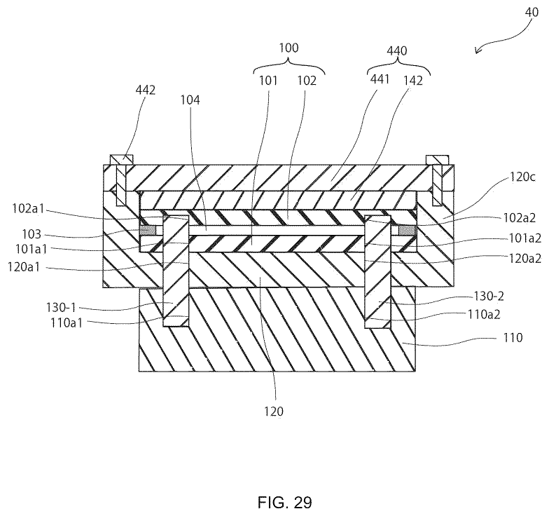

FIG. 29 is a cross-sectional view of an optical apparatus 40 according to Modified Example 2 of the first embodiment.

In the optical apparatus 40 according to Modified Example 2 of the first embodiment, as shown in FIG. 29, a cap unit 440 includes a cap member 441 having a flat plate shape and a soft resin sheet 142 bonded to an inner surface of the cap member 441. The cap member 441 is detachably fixed to the fixing unit 120 with a screw 442.

That is, the cap unit 440 does not fit on the fixing unit 120 in the optical apparatus 40 according to Modified Example 2.

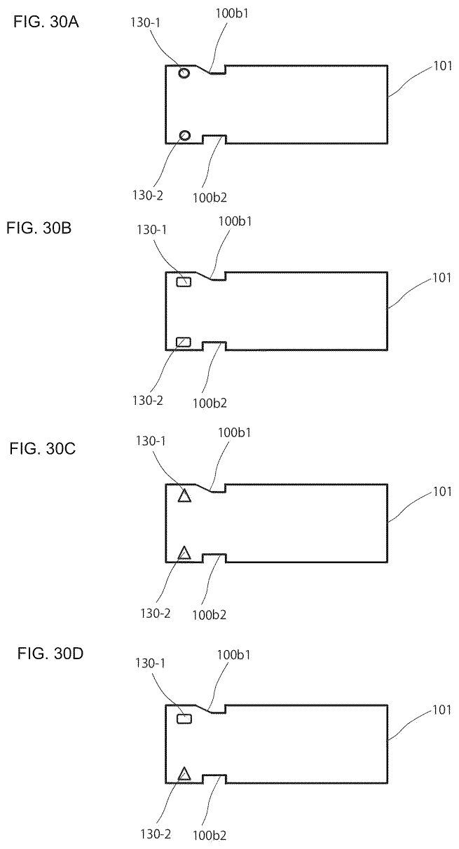

A of FIG. 30 to D of FIG. 30 are views showing variations of the shapes of the pins penetrating the light guide plate 101. As to cross-section shapes of the first and second pins 130-1 and 130-2 that penetrate the light guide plate 101 and cross-section shapes of the corresponding first through-holes 101a1 and 101a2 of the light guide plate 101, as described above, it is desirable that the user can recognize the front and back sides of the light guide plate unit 100 at a glance on the basis of the relationship between the second fitting portions 120b1 and 120b2 and the second through-holes 120a1 and 120a2 that are provided in the fixing unit 120.

For example, as shown in A of FIG. 30, the cross-sections of the first and second pins 130-1 and 130-2 and the corresponding first through-holes may be the same in shape (e.g., circular shapes) and the two first fitting portions 100b1 and 100b2 may be different in shape.

For example, as shown in B of FIG. 30, the cross-sections of the first and second pins 130-1 and 130-2 and the corresponding first through-holes may be the same in shape (e.g., rectangular shapes) and the two first fitting portions 100b1 and 100b2 may be different in shape.

For example, as shown in C of FIG. 30, the cross-sections of the first and second pins 130-1 and 130-2 and the corresponding first through-holes may be the same in shape (e.g., triangular shapes) and the two first fitting portions 100b1 and 100b2 may be different in shape.

For example, as shown in D of FIG. 30, the cross-sections of the first and second pins 130-1 and 130-2 and the corresponding first through-holes may be different in shape (e.g., a rectangular shape and a triangular shape) and the two first fitting portions 100b1 and 100b2 may be different in shape.

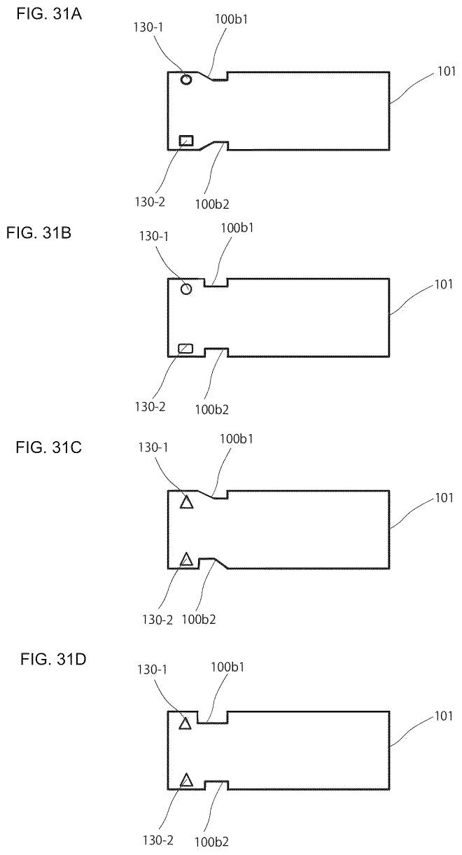

A of FIG. 31 to D of FIG. 31 are views showing variations of a combination of shapes of the pins penetrating the light guide plate 101 and the first fitting portions of the light guide plate 101.

For example, as shown in A of FIG. 31, the cross-sections of the first and second pins 130-1 and 130-2 and the corresponding first through-holes may be different in shape (e.g., a circular shape and a rectangular shape) and the two first fitting portions 100b1 and 100b2 may be symmetrically arranged to be the same in shape (e.g., partially wedge shapes).

For example, as shown in B of FIG. 31, the cross-sections of the first and second pins 130-1 and 130-2 and the corresponding first through-holes may be different in shape (e.g., a circular shape and a rectangular shape) and the two first fitting portions 100b1 and 100b2 may be symmetrically arranged to be the same in shape (e.g., rectangular shapes).

For example, as shown in C of FIG. 31, the cross-sections of the first and second pins 130-1 and 130-2 and the corresponding first through-holes may be the same in shape (e.g., triangular shapes) and the two first fitting portions 100b1 and 100b2 may be asymmetrically arranged to be the same in shape (e.g., partially wedge shapes).

For example, as shown in D of FIG. 31, the cross-sections of the first and second pins 130-1 and 130-2 and the corresponding first through-holes may be the same in shape (e.g., triangular shapes) and the two first fitting portions 100b1 and 100b2 may be the same in shape (e.g., rectangular shapes) and different in size.

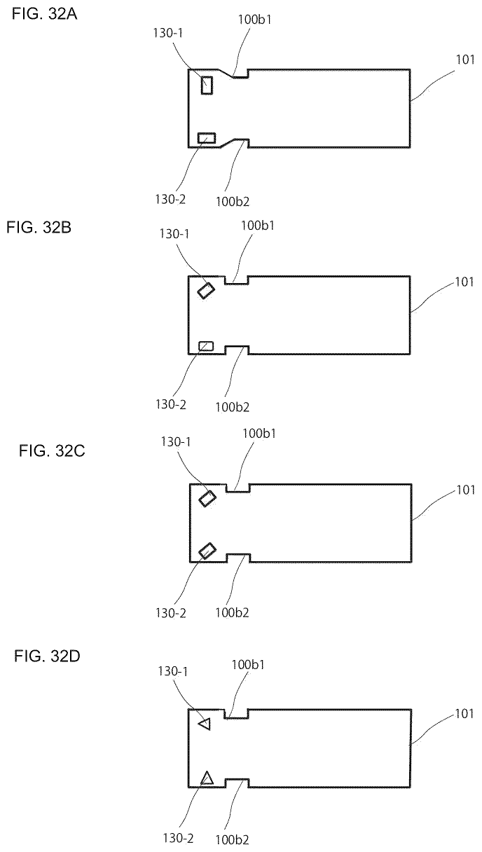

A of FIG. 32 to D of FIG. 32 are views showing variations of the shapes and orientations of the pins penetrating the light guide plate 101.

For example, as shown in A of FIG. 32, the cross-sections of the first and second pins 130-1 and 130-2 and the corresponding first through-holes may be the same in shape (e.g., rectangular shapes) and different in orientation and the two first fitting portions 100b1 and 100b2 may be symmetrically arranged to be the same in shape (e.g., partially wedge shapes).

For example, as shown in B of FIG. 32, the cross-sections of the first and second pins 130-1 and 130-2 and the corresponding first through-holes may be the same in shape (e.g., rectangular shapes) and different in orientation and the two first fitting portions 100b1 and 100b2 may be symmetrically arranged to be the same in shape (e.g., rectangular shapes).

For example, as shown in C of FIG. 32, the cross-sections of the first and second pins 130-1 and 130-2 and the corresponding first through-holes may be asymmetrically arranged to be the same in shape (e.g., rectangular shapes) and the same in orientation and the two first fitting portions 100b1 and 100b2 may be symmetrically arranged to be the same in shape (e.g., rectangular shapes).

For example, as shown in D of FIG. 32, the cross-sections of the first and second pins 130-1 and 130-2 and the corresponding first through-holes may be the same in shape (e.g., triangular shapes) and different in orientation and the two first fitting portions 100b1 and 100b2 may be symmetrically arranged to be the same in shape (e.g., rectangular shapes).

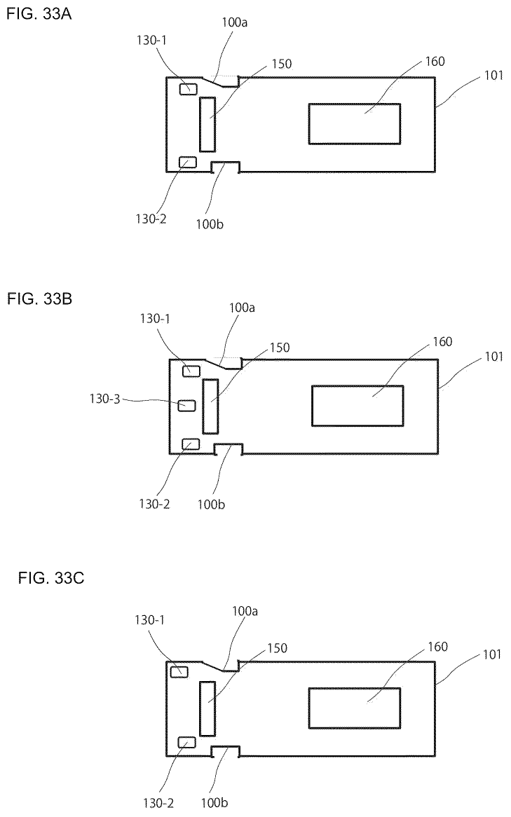

A of FIG. 33 to C of FIG. 33 are views showing variations of the arrangement of the pins penetrating the light guide plate 101 and the corresponding first through-holes.

For example, as shown in A of FIG. 33, the first and second pins 130-1 and 130-2 and the corresponding first through-holes may be symmetrically arranged.

For example, as shown in B of FIG. 33, a third pin 130-3 and the corresponding first through-hole may be disposed between the first and second pins 130-1 and 130-2.

For example, as shown in C of FIG. 33, the first and second pins 130-1 and 130-2 and the corresponding first through-holes may be asymmetrically arranged.

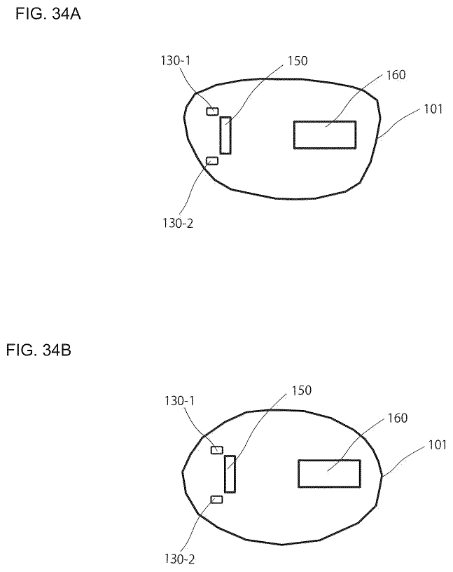

A of FIG. 34 and B of FIG. 34 are views showing variations of the light guide plate shape.

For example, as shown in A of FIG. 34 and B of FIG. 34, various shapes (e.g., a Boston shape or a Wellington shape (see FIG. 41)) can be employed as the shape of the light guide plate 101 for example like an eyeglass lens.

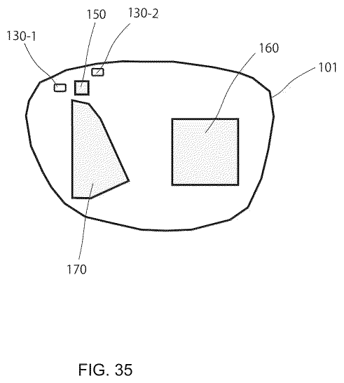

As shown in FIG. 35, the light guide plate 101 may be provided with an intermediate optical unit 170 on the optical path of the image light between the incident optical unit 150 and the emission optical unit 160.

The optical apparatus according to each of the above-mentioned first embodiment and the modified examples thereof includes two sets of the first fitting portions provided in the light guide plate unit 100 and the second fitting portions provided in the fixing unit 120. However, the optical apparatus according to each of the above-mentioned first embodiment and the modified examples thereof may include one set (e.g., one set at only either one of the light guide plate unit 100 and the fixing unit 120) or may include three or more sets. In a case where the optical apparatus includes three or more sets, the first and second fitting portions of the at least two sets may be different in shape or may be the same in shape.

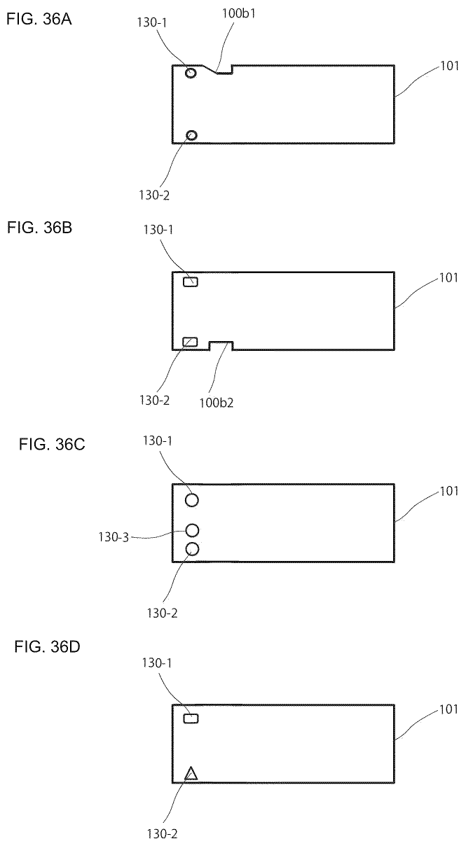

A of FIG. 36 to D of FIG. 36 are views showing variations of the shapes and the number of pins penetrating the light guide plate 101 and the corresponding first through-holes and the presence/absence of the first fitting portion.

For example, as shown in A of FIG. 36, the first and second pins 130-1 and 130-2 are the same in shape and the same in size (e.g., circular shapes having cross-sections with the same diameter) may be symmetrically arranged and a cutout (e.g., a partially wedge shape) as the first fitting portion 100b1 may be provided on only one side of the light guide plate 101. In this case, a convex portion as the second fitting portion 120b1 that substantially fits to the first fitting portion 100b1 is favorably provided on one side of the fixing unit 120.

For example, as shown in B of FIG. 36, the first and second pins 130-1 and 130-2 are the same in shape and the same in size (e.g., rectangular shapes having identical cross-sections) may be symmetrically arranged and a cutout (e.g., a rectangular shape) as the first fitting portion 100b2 may be provided on only one side of the light guide plate 101. In this case, a convex portion as the second fitting portion 120b2 that substantially fits to the first fitting portion 100b2 is favorably provided on one side of the fixing unit 120.

For example, as shown in C of FIG. 36, a configuration in which the first and second fitting portions are not provided and the third pin 130-3 (e.g., with a circular cross-section) is provided at a position deviated from the center position between the first and second pins 130-1 and 130-2 (e.g., with circular cross-sections) may be employed.

For example, as shown in D of FIG. 36, a configuration in which the first and second fitting portions are not provided and the first and second pins 130-1 and 130-2 with different cross-section shapes are provided may be employed.

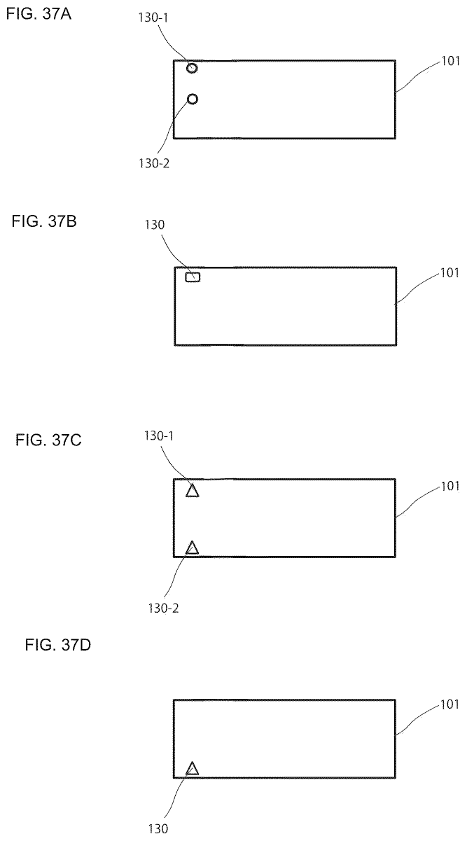

A of FIG. 37 to D of FIG. 37 are views showing variations of the pin shape, the number of pins, and the pin arrangement in the optical apparatus according to the present technology.

For example, as shown in A of FIG. 37, a configuration in which the first and second fitting portions are not provided and the first and second pins 130-1 and 130-2 with the same cross-section shapes (e.g., circular shapes) are provided in a region ranging from the center portion to the one end portion of the light guide plate 101 may be employed.

For example, as shown in B of FIG. 37, a configuration in which the first and second fitting portions are not provided and the pin 130 whose cross-section shape is a polygonal shape (e.g., a rectangular shape) is provided on one end side with respect to the center portion of the light guide plate 101 may be employed.

For example, as shown in C of FIG. 37, a configuration in which the first and second fitting portions are not provided and the first and second pins 130-1 and 130-2 having the same cross-section shapes (e.g., triangular shapes) are respectively provided in one end portion and the other end portion of the light guide plate 101 in an asymmetric arrangement may be employed.

For example, as shown in D of FIG. 37, a configuration in which the first and second fitting portions are not provided and the pin 130 whose cross-section shape is a polygonal shape (e.g., a triangular shape) is provided on one end side with respect to the center portion of the light guide plate 101 may be employed.

A of FIG. 38 to C of FIG. 38 are views (Part 1 to Part 3) showing an assembling method for an image display apparatus 3 including the optical apparatus according to Modified Example 3 of the first embodiment.

A of FIG. 38 to As shown in C of FIG. 38, in the light guide plate unit 100 of the image display apparatus 3, two second insertion holes formed in the cover plate 102 are both through-holes. In this case, machining of each second insertion hole is easier. It should be noted that only one of the two second insertion holes may be a through-hole.

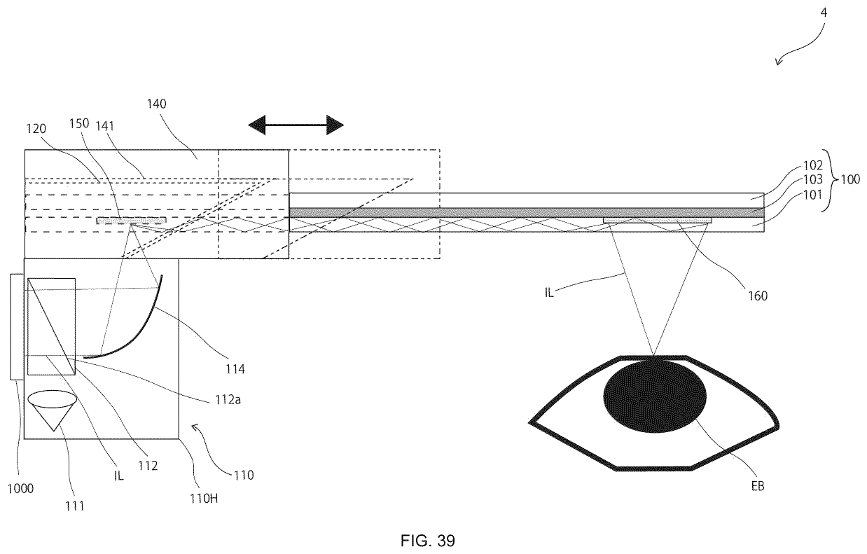

FIG. 39 is a side view of an image display apparatus 4 including the optical apparatus according to Modified Example 4 of the first embodiment.

In the image display apparatus 4, as shown in FIG. 39, as an example, an image light generation unit 1000 is disposed on one side of the optical unit 110 in a direction orthogonal to an incident direction of image light IL, the image light IL being incident upon the light guide plate unit 110. The light 111 and the prism 112 are arranged along the incident direction, for example. The prism 112 is arranged so that the longitudinal direction is substantially parallel to the incident direction, for example.

A parabolic mirror 114 is arranged on the optical path of the image light IL which has been generated by the image light generation unit 1000 and has passed through the prism 112.

In the image display apparatus 4, a portion of the light from the light 111 is reflected on an optical surface 112a (e.g., a half mirror surface) of the prism 112, such that it enters substantially the entire surface of a liquid-crystal panel of the image light generation unit 1000. The image light generation unit 1000 reflects at least a portion of incident light so as to generate image light IL. The generated image light IL partially passes through the optical surface 112a of the prism 112 and enters the parabolic mirror 114 and is reflected by the parabolic mirror 114 towards the incident optical unit 150.

The image display apparatus 4 is effective because it enables the optical unit 110 to be spaced apart from the user's temples.

It should be noted that the parabolic mirror 114 may be replaced by a concave mirror, a freely curved mirror, or the like other than the parabolic mirror 114.

The positioning structure of the fixing mechanism of the optical apparatus 20 according to the second embodiment described above may include a plurality of pins.

The number and arrangement of the pin(s) of the positioning structure of the fixing mechanism of the optical apparatus according to the present technology are not limited to those of the above-mentioned embodiments and modified examples and can be modified as appropriate. For example, four or more pins may be used.

The optical apparatus 10 according to the above-mentioned first embodiment employs the configuration in which the cap unit 140 slidably fits onto the fixing unit 120. However, for example, a configuration in which the cap unit 140 covers the fixing unit 120 and the cap unit 140 slidably fits onto the optical unit 110 may be employed. In this case, it is not essential to fix the fixing unit 120 to the optical unit 110.

In the optical apparatus 10 according to the above-mentioned first embodiment, the cap unit 140 is configured to be inserted from the side opposite to the side of the side wall portion 122-3 and slidably fit onto the fixing unit 120. However, the cap unit 140 may be configured to be inserted from the side of the side wall portion 122-3 and slidably fit onto the fixing unit 120.

The optical apparatus 10 according to the above-mentioned first embodiment employs the configuration in which the cap unit 140 entirely fits onto the fixing unit 120, though not limited thereto. For example, a hook may be provided in one of the cap unit 140 and the fixing unit 120 and a groove with which the hook is engaged may be provided in the other.

In the optical apparatus 10 according to the above-mentioned first embodiment, the box-shaped member is used as the fixing unit 120, though not limited thereto. For example, a plate-like member may be used.

In the optical apparatus 10 according to the above-mentioned first embodiment, the fixing mechanism 125 does not need to include the fixing unit 120. In this case, the light guide plate unit 100 may be directly disposed on the optical unit 110 while for example positioning the light guide plate unit 100 and the optical unit 110 through at least one pin. In this case, the cap unit 140 may be configured to be attachable and detachable to/from the optical unit 110. In this case, the cap unit 140 may be configured to slidably fit onto the optical unit 110.

In the optical apparatus 10 according to each of the above-mentioned first embodiment and the modified examples thereof, the light guide plate unit 100 does not need to include the cover plate 102.

The optical apparatus 10 according to the above-mentioned first embodiment and the modified examples thereof may include a hard resin sheet, a metal sheet, an alloy sheet, or the like instead of the soft resin sheet 142.

A non-sheet-like (e.g., at least one block-like) member made of a soft resin may be used as a soft resin member instead of the soft resin sheet 142.

In the optical apparatus 10 according to each of the above-mentioned first embodiment and the modified examples thereof, the second fitting portions provided in the fixing unit 120 may be cutouts and the first fitting portions provided in the light guide plate unit 100 may be convex portions that have shapes corresponding to the cutouts and enter the cutouts.

In the optical apparatus 10 according to each of the above-mentioned first embodiment and the modified examples thereof, one first fitting portion provided in the light guide plate unit 100 may be a cutout, the other first fitting portion may be a convex portion, one second fitting portion provided in the fixing unit 120 may be a convex portion that has a shape corresponding to the cutout and enters the cutout, and the other second fitting portion may be a cutout that has a shape corresponding to the convex portion as the other first fitting portion and enters the convex portion.

In the optical apparatus according to each of the respective embodiments and the respective modified examples described above, the cross-section orthogonal to the longitudinal direction of the pin of the positioning structure may have any shape such as a circular shape, an elliptical shape, a polygonal shape (also including a triangular shape), a star-shape, and a gear-shape.

In each of the respective embodiments and the respective modified examples described above, the image light generation unit 1000 may include a transmissive liquid-crystal panel and a backlight. In this case, the optical unit 110 may include at least one optical element, e.g., a lens or a mirror.

In each of the respective embodiments and the respective modified examples described above, the image light generation unit 1000 includes the liquid-crystal panel, though not limited thereto.

For example, the image light generation unit 1000 may include a light-emitting element array, e.g., an LED array or an organic electro-luminescence (EL) array. In this case, the image light generation unit 1000 generates image light by driving the light-emitting element array on the basis of image data.

In this case, the optical unit 110 may include at least one optical element, e.g., a lens, a mirror, or a prism that guides image light from the light-emitting element array to the light guide plate unit 100.

Moreover, the image light generation unit 1000 may include, for example, a light source (e.g., a semiconductor laser) and a deflector (e.g., a micro electro mechanical systems (MEMS) mirror) that one-dimensionally or two-dimensionally deflects light from the light source. In this case, the image light generation unit 1000 generates image light by synchronously controlling the light source and the deflector on the basis of image data.

In this case, the optical unit 110 may include at least one optical element, e.g., a lens, a mirror, or a prism that guides image light from the light-emitting element array to the light guide plate unit 100.

In each of the respective embodiments and the respective modified examples described above, the pin penetrates the light guide plate. However, the pin only needs to be at least inserted in the light guide plate and the pin does not need to penetrate the light guide plate. In this case, the pin-inserting hole formed in the light guide plate may be a through-hole or does not need to be a through-hole.

Some of the configurations of the respective embodiments and the respective modified examples described above may be combined with each other in a reasonable range.

Moreover, the present technology can also take the following configurations.
(1) An optical apparatus, including:
   a light guide plate unit including a light guide plate;
   an optical unit that guides incident light to the light guide plate unit; and
   a fixing mechanism that detachably fixes the light guide plate unit to the optical unit.
(2) The optical apparatus according to (1), in which
   the fixing mechanism includes a positioning structure that positions the light guide plate unit and the optical unit.
(3) The optical apparatus according to (2), in which
   the positioning structure has at least one pin that penetrates the light guide plate, and
   the pin has a portion on one end side protruding from the light guide plate, the portion being inserted in the optical unit.
(4) The optical apparatus according to (3), in which
   the fixing mechanism includes
      a fixing unit fixed to the optical unit, the fixing unit having at least a portion located between the light guide plate unit and the optical unit, and
      a cap unit that covers the light guide plate unit at least from a side opposite to a side of the optical unit, the cap unit including a cap member attachable and detachable to/from the fixing unit, and
   the pin penetrates the light guide plate and the at least portion.
(5) The optical apparatus according to (4), in which
   the cap member is attachable and detachable by being slid with respect to the fixing unit.
(6) The optical apparatus according to (4) or (5), in which
   the cap member slidably fits in the fixing unit.
(7) The optical apparatus according to (3), in which
   the fixing mechanism includes a cap unit that covers the light guide plate unit at least from a side opposite to a side of the optical unit, the cap unit including a cap member attachable and detachable to/from the optical unit, and
   the pin penetrates the light guide plate.
(8) The optical apparatus according to (7), in which
   the cap member is attachable and detachable by being slid with respect to the optical unit.
(9) The optical apparatus according to (7) or (8), in which
   the cap member slidably fits onto the optical unit.
(10) The optical apparatus according to any one of (4) to (9), in which
   the cap unit further includes a soft resin member disposed between the cap member and the light guide plate unit.
(11) The optical apparatus according to any one of (4) to (10), in which
   the pin is fixed to the fixing unit and is not fixed to the optical unit.
(12) The optical apparatus according to any one of (4) to (10), in which
   the pin is fixed to the optical unit.
(13) The optical apparatus according to any one of (4) to (12), in which
   the light guide plate unit further includes
      a cover plate that is arranged so as to form a gap with respect to a surface of the light guide plate that is on the side of the optical unit, and/or
      a cover plate that is arranged so as to form a gap with respect to a surface of the light guide plate that is on a side opposite to the side of the optical unit.
(14) The optical apparatus according to (13), in which
   the pin has a portion on one end side protruding from the light guide plate and/or a portion of another end side, the portion being inserted in the cover plate.
(15) The optical apparatus according to any one of (4) to (14), in which
   the light guide plate unit includes a first fitting portion that substantially fits to the fixing unit, and
   the fixing unit includes a second fitting portion that substantially fits to the first fitting portion.
(16) The optical apparatus according to (15), in which
   a plurality of sets of the first and second fitting portions that substantially fit to each other is provided, and
   the first and second fitting portions of at least two sets of the plurality of sets are different in shape.
(17) The optical apparatus according to (15) or (16), in which
   one of the first and second fitting portions is a cutout, and
   the other of the first and second fitting portions is a convex portion that has a shape corresponding to a shape of the cutout and enters the cutout.
(18) The optical apparatus according to (2), in which
   the light guide plate unit includes a frame-like member in which the light guide plate is fitted,
   the positioning structure has at least one pin that penetrates the frame-like member,
   the pin has a portion on one end side protruding from the frame-like member and inserted in the optical unit, and
   the fixing mechanism further includes a fixing member that detachably fixes to the optical unit the frame-like member pushed against the optical unit.
(19) The optical apparatus according to (18), in which
   the fixing member is a screw that is threadedly engaged with a threaded hole formed in the optical unit.
(20) The optical apparatus according to any one of (3) to (19), in which
   the at least one pin is a plurality of pins.
(21) The optical apparatus according to any one of (3) to (20), in which
   the plurality of pins includes at least two pins having cross-sections different in shape.
(22) The optical apparatus according to any one of (3) to (19), in which
   the at least one pin is a single pin having a polygonal cross-section.
(23) An image display apparatus, including:
   the optical apparatus according to any one of (1) to (22); and
   an image light generation unit that causes image light to enter an optical unit of the optical apparatus, in which
   the image light that has passed through a light guide plate unit of the optical apparatus is made to enter an eyeball of a user.
(24) The image display apparatus according to (23), in which
   the image light generation unit is mounted to the optical unit.
(25) The image display apparatus according to (23) or (24), in which
   the light guide plate unit includes
      an incident optical unit that causes the image light that has passed through the optical unit to enter the light guide plate, and
      an emission optical unit that emits the image light that has propagated inside the light guide plate towards the eyeball.
(26) The image display apparatus according to (25), in which
   the light guide plate unit further includes an intermediate optical unit arranged on an optical path of the image light between the incident optical unit and the emission optical unit.

### REFERENCE SIGNS LIST

1, 2: image display apparatus, 10, 20, 30, 40: optical apparatus, 100, 200: light guide plate unit, 100b1, 100b2: first fitting portion, 110, 210: optical unit, 120b1, 120b2: second fitting portion, 101, 201: light guide plate, 102: cover plate, 202: frame-like member, 120: fixing unit, 125, 225: fixation mechanism, 127, 227: positioning structure, 130, 130-1, 130-2, 130-3: pin, 140, 440: cap unit, 141, 441: cap member, 142: soft resin sheet, 150: incident optical unit, 160: emission optical unit, 170: intermediate optical unit, 250: fixing member, 1000: image light generation unit, IL: image light.

1. An optical apparatus, comprising:
a light guide plate unit including a light guide plate;
an optical unit that guides incident light to the light guide plate unit; and
a fixing mechanism that detachably fixes the light guide plate unit to the optical unit.

2. The optical apparatus according to claim 1, wherein
the fixing mechanism includes a positioning structure that positions the light guide plate unit and the optical unit.

3. The optical apparatus according to claim 2, wherein
the positioning structure has at least one pin that penetrates the light guide plate, and
the pin has a portion on one end side protruding from the light guide plate, the portion being inserted in the optical unit.

4. The optical apparatus according to claim 3, wherein
the fixing mechanism includes
a fixing unit fixed to the optical unit, the fixing unit having at least a portion located between the light guide plate unit and the optical unit, and
a cap unit that covers the light guide plate unit at least from a side opposite to a side of the optical unit, the cap unit including a cap member attachable and detachable to/from the fixing unit, and
the pin penetrates the light guide plate and the at least portion.

5. The optical apparatus according to claim 4, wherein
the cap member is attachable and detachable by being slid with respect to the fixing unit.

6. The optical apparatus according to claim 4, wherein
the cap member slidably fits in the fixing unit.

7. The optical apparatus according to claim 4, wherein
the cap unit further includes a soft resin member disposed between the cap member and the light guide plate unit.

8. The optical apparatus according to claim 4, wherein
the pin is fixed to the fixing unit and is not fixed to the optical unit.

9. The optical apparatus according to claim 4, wherein
the pin is fixed to the optical unit.

10. The optical apparatus according to claim 1, wherein
the light guide plate unit further includes
a cover plate that is arranged so as to form a gap with respect to a surface of the light guide plate that is on the side of the optical unit, and/or
a cover plate that is arranged so as to form a gap with respect to a surface of the light guide plate that is on a side opposite to the side of the optical unit.

11. The optical apparatus according to claim 10, wherein
the pin has a portion on one end side protruding from the light guide plate and/or a portion of another end side, the portion being inserted in the cover plate.

12. The optical apparatus according to claim 4, wherein
the light guide plate unit includes a first fitting portion that substantially fits to the fixing unit, and
the fixing unit includes a second fitting portion that substantially fits to the first fitting portion.

13. The optical apparatus according to claim 12, wherein
a plurality of sets of the first and second fitting portions that substantially fit to each other is provided, and
the first and second fitting portions of at least two sets of the plurality of sets are different in shape.

14. The optical apparatus according to claim 12, wherein
one of the first and second fitting portions is a cutout, and
the other of the first and second fitting portions is a convex portion that has a shape corresponding to a shape of the cutout and enters the cutout.

15. The optical apparatus according to claim 2, wherein
the light guide plate unit includes a frame-like member in which the light guide plate is fitted,
the positioning structure has at least one pin that penetrates the frame-like member,
the pin has a portion on one end side protruding from the frame-like member and inserted in the optical unit, and
the fixing mechanism further includes a fixing member that detachably fixes to the optical unit the frame-like member pushed against the optical unit.

16. The optical apparatus according to claim 15, wherein
the fixing member is a screw that is threadedly engaged with a threaded hole formed in the optical unit.

17. The optical apparatus according to claim 3, wherein
the at least one pin is a plurality of pins.

18. The optical apparatus according to claim 17, wherein
the plurality of pins includes at least two pins having cross-sections different in shape.

19. The optical apparatus according to claim 3, wherein
the at least one pin is a single pin having a polygonal cross-section.

20. An image display apparatus, comprising:
the optical apparatus according to claim 1; and
an image light generation unit that causes image light to enter an optical unit of the optical apparatus, wherein
the image light that has passed through a light guide plate unit of the optical apparatus is made to enter an eyeball of a user.

21. The image display apparatus according to claim 20, wherein
the image light generation unit is mounted to the optical unit.

22. The image display apparatus according to claim 20, wherein
the light guide plate unit includes
an incident optical unit that causes the image light that has passed through the optical unit to enter the light guide plate, and
an emission optical unit that emits the image light that has propagated inside the light guide plate towards the eyeball.

23. The image display apparatus according to claim 22, wherein
the light guide plate unit further includes an intermediate optical unit arranged on an optical path of the image light between the incident optical unit and the emission optical unit.
